(19) United States
(12) Patent Application Publication
(10) Pub. No.: US 2024/0341301 A1
(43) Pub. Date: Oct. 17, 2024

(54) ITACONATE AND DERIVATIVES THEREOF FOR THE PROTECTION OF CELLS, TISSUES, AND ORGANS

(71) Applicant: The Regents of the University of Michigan, Ann Arbor, MI (US)

(72) Inventors: Paul C. TANG, Annr Arbor, MI (US); Y. Eugene Chen, Ann Arbor, MI (US); Lenglam Lei, Ann Arbor, MI (US)

(21) Appl. No.: 18/627,185

(22) Filed: Apr. 4, 2024

Related U.S. Application Data
(60) Provisional application No. 63/494,170, filed on Apr. 4, 2023.

(51) Int. Cl. A01N 1/02

(52) U.S. Cl. CPC A01N 1/0226

(57) ABSTRACT

Provided herein are pharmaceutical compositions and tissue/organ preservation solutions comprising itaconate and/or derivatives thereof and methods of use thereof. In particular, provided herein are compositions comprising itaconate and methods of use thereof for the preservation of tissues/organs for transplantation and treatment/prevention/reduction of conditions such as myocardial infarction, sudden cardiac arrest, stroke, senescence, cardiomyopathies, and cardiotoxicity.

The present application claims priority to U.S. Provisional Application No. 63/494,170, filed Apr. 4, 2023, which is herein incorporated by reference in its entirety.

### STATEMENT REGARDING GOVERNMENT INTEREST

This invention was made with government support under HL164416 awarded by the National Institutes of Health. The government has certain rights in the invention.

### FIELD

Provided herein are pharmaceutical compositions and tissue/organ preservation solutions comprising itaconate and/or derivatives thereof and methods of use thereof. In particular, provided herein are compositions comprising itaconate and methods of use thereof for the preservation of tissues/organs for transplantation and treatment/prevention/reduction of conditions such as myocardial infarction, sudden cardiac arrest, stroke, senescence, cardiomyopathies, and cardiotoxicity.

### BACKGROUND

Heart failure is a major health care challenge that impacts about 6.5 million adults in the United States (1). Although heart transplantation is the most effective therapeutic modality for end stage heart failure, a shortage in donor hearts exists due to demand exceeding supply (2). Unfortunately, fewer than 50% of potential donors become actual heart donors (3). One contributor to donor heart under-utilization is the 4-hour limit on ischemia during mechanical arrest with cold storage (4). This restricts the geographic distribution of hearts due to limitations in transport time. Prolonged ischemic time is a risk factor for primary graft dysfunction (PGD) (5), a condition in which donor heart contraction and output are insufficient for end organ perfusion. PGD occurs in 10-20% of heart transplants (5).

Although mortality one month after heart transplant is about 8%, PGD accounts for 39% of these deaths (6). Treatment of cardiogenic shock from PGD is also very costly for patients and society (6). Recent clinical use of ex vivo normothermic human heart perfusion platforms has shortened the time an organ is subjected to cold ischemia. However, donor hearts must still undergo preservation solution-induced cardiac arrest. Arresting the donor heart to place it on the perfusion system and subsequent re-arrest of the heart to disengage it from the apparatus for transplantation impose obligate ischemic time. In a recent clinical trial assessing an ex vivo cardiac perfusion system, severe left ventricle (LV) or right ventricle (RV) PGD remained high at 10.7% despite normothermic cardiac perfusion during organ transport to the recipient hospital (7).

### SUMMARY

Provided herein are pharmaceutical compositions and tissue/organ preservation solutions comprising itaconate and/or derivatives thereof and methods of use thereof. In particular, provided herein are compositions comprising itaconate and methods of use thereof for the preservation of tissues/organs for transplantation and treatment/prevention/reduction of conditions such as myocardial infarction, sudden cardiac arrest, stroke, senescence, cardiomyopathies, and cardiotoxicity.

In some embodiments, provided herein are preservation fluids comprising a solution of itaconate and/or an itaconate derivative. In some embodiments, the itaconate derivative is 4-octyl itaconate, dimethyl itaconate, or citraconate. In some embodiments, preservation fluids further comprise buffer. In some embodiments, the buffer is selected from phosphate, bicarbonate, and histidine. In some embodiments, preservation fluids further comprise a physiologically-relevant concentrations of cations and anions. In some embodiments, the cations and anions are selected from potassium, calcium, magnesium, chloride, bicarbonate, hydroxide, and sulfate ions. In some embodiments, the cations and anions are independently present at 0.01 to 200 mM (e.g., 0.01, 0.02, 0.05, 0.1, 0.2, 0.5, 1, 2, 5, 10, 20, 50, 100, or 200 mM, or ranges therebetween). In some embodiments, preservation fluids have an osmolarity of 250-500 mOsm/L (e.g., 250, 300, 350, 400, 450, or 500 mOsm/L, or ranges therebetween). In some embodiments, the itaconate and/or an itaconate derivative is present at a concentration of 1-100 mM (e.g., 1, 2, 5, 10, 20, 30, 40, 50, 75, or 100 nM, or ranges therebetween). In some embodiments, the itaconate and/or an itaconate derivative is present at a concentration of 5-50 mM (e.g., 5, 10, 20, 30, 40, or 50 mM, or ranges therebetween). In some embodiments, the itaconate and/or an itaconate derivative is present at a concentration of 10-30 mM (e.g., 10, 15, 20, 25, or 30, or ranges therebetween). In some embodiments, the itaconate and/or an itaconate derivative is present at a concentration of 15-25 mM. In some embodiments, preservation fluids further comprise one or more impermeants, antioxidants, and/or other components. In some embodiments, preservation fluids further comprise one or more impermeants selected from lucose, LactoB, raffinose, mannitol, dextran, and albumin. In some embodiments, preservation fluids further comprise one or more antioxidants selected from allopurinol (AlloP), glutathione (GSH), tryptophan (Trp), and mannitol. In some embodiments, preservation fluids further comprise other components selected from α-ketoglutarate, dextran, blood, heparin, glucose, adenosine, and an amiloride-containing compound. In some embodiments, preservation fluids further comprise a mineralocorticoid receptor antagonist. In some embodiments, the mineralocorticoid receptor antagonist is selected from spironolactone, eplerenone, canrenoic acid, canrenone, and drospirenone. In some embodiments, preservation fluids further comprise an aldehyde dehydrogenase agonist. In some embodiments, the aldehyde dehydrogenase agonist is selected from Alda-1, Alda-89, Alda-52, Alda-59, Alda-72, Alda-71, Alda-53, Alda-54, Alda-61, Alda-60, Alda-66, Alda-65, Alda-64, and Alda-84. In some embodiments, preservation fluids further comprise a histone deacetylase inhibitor. In some embodiments, the histone deacetylase inhibitor is selected from a hydroxamic acid, depsipeptide, benzamide; electrophilic ketone, phenylbutyrate and valproic acid, nicotinamide, and NA derivatives.

In some embodiments, provided herein are methods of preserving an organ or tissue comprising exposing the organ to a preservation fluid described herein. In some embodiments, methods comprise perfusing the organ with the preservation fluid. In some embodiments, methods further comprise storing the organ at a temperature between −10° C. and 10° C. (e.g., −10° C., −5° C., 0° C., 5° C., or 10° C., or ranges therebetween). In some embodiments, the organ is selected from a heart, kidneys, liver, lungs, pancreas, intestine, and thymus. In some embodiments, the tissue is selected from bones, tendons, corneae, skin, heart valves, nerves and veins. In some embodiments, methods further comprise removing the organ or tissue from a donor. In some embodiments, the organ or tissue is exposed to the preservation fluid after being removed from the donor. In some embodiments, the organ is a heart. In some embodiments, methods further comprise arresting the heart with a cardioplegic solution prior to removal from the donor.

In some embodiments, provided herein are methods of preserving an organ or tissue comprising exposing the organ to a preservation fluid comprising itaconate and/or an itaconate derivative.

In some embodiments, provided herein are methods of treating/preventing organ/tissue injury in a subject comprising administering itaconate and/or an itaconate derivative to the subject. In some embodiments, the subject has suffered a tissue and/or organ injury. In some embodiments, the subject suffers from a disease or condition, or has suffered a physiological event, that causes tissue and/or organ injury. In some embodiments, the subject is at elevated risk of a disease, condition, or physiological event, that causes tissue and/or organ injury. In some embodiments, the tissue and/or organ injury comprises cardiac damage. In some embodiments, the tissue and/or organ injury comprises ischemic damage. In some embodiments, the subject has suffered a myocardial infarction, cardiac arrest, and/or a stroke.

In some embodiments, provided herein are methods of reducing cardiotoxicity in a subject in need thereof, comprising administering itaconate and/or an itaconate derivative to the subject. In some embodiments, the subject suffers from drug-induced cardiotoxicity. In some embodiments, the subject has been administered a chemotherapeutic.

In some embodiments, provided herein are methods of treating a cancer in a subject with reduced cardiotoxicity comprising co-administering itaconate and/or an itaconate derivative and a chemotherapeutic to the subject.

In some embodiments, provided herein are methods of reducing senescence in a cell or subject comprising administering itaconate and/or an itaconate derivative to the subject.

In some embodiments, provided herein are methods of preventing or reducing the likelihood of acute heart failure, chronic heart failure, and/or cardiomyopathies in a subject comprising administering itaconate and/or an itaconate derivative to the subject. In some embodiments, the subject has been administered a chemotherapeutic.

### BRIEF DESCRIPTION OF THE DRAWINGS

FIG. 1. Treatment with VPA during cardiac preservation maintains histone acetylation, improved cardiac function and reduced inflammation and cell death. (A) Representative Western blot for total acetylated H3K9 in human donor hearts following cold (4° C.) preservation for 0 and 8 hours with or without VPA treatment. Quantitative H3K9ac values are expressed as a proportion of total H3 histone expression and then normalized to expression values at 0 hour preservation with HTK only (n=4/group). (B and C) Standard cold (4° C.) HTK solution with or without VPA (10 mM) was used to preserve murine donor hearts for 0, 4, 8 or 16 hours. Following subsequent ex-vivo perfusion with Krebs buffer (n=5-9/group), cardiac (B) contractility (max dP/dt) and (C) relaxation (min dP/dt) were. (D) Schematic for syngeneic heart transplant experiment. Murine donor hearts were isolated and preserved in cold (4° C.) HTK solution with or without VPA for 16 hours before sex-matched syngeneic heterotopic heart transplantation. (E-F) Donor heart contractility (max dP/dt) (E) and relaxation (min dP/dt) (F) were measured in vivo 24 hours after transplantation (n=9/group). (G) ELISA quantification of serum cardiac troponin T, cardiac troponin I, IL-6, TNFα, IP-10 and MIG (n=8-9/group). (H) Representative immunofluorescence staining of CD45⁺ panleukocyte infiltration (red) in left ventricular tissue of transplanted murine hearts. DAPI used to visualize nuclei (blue). (I) Quantification of data from panel H (n=4/group). (J) (K) Quantification of terminal deoxynucleotidyl transferase dUTP nick end labeling positive cell (TUNEL⁺) images from transplanted murine hearts (green, n=4/group). DAPI used to visualize nuclei (blue). Data are presented as mean±SD. *P<0.05, and **P<0.01 Kruskal Wallis test followed by Dunn's multiple comparisons test (A) or Student's t test (B-C, E-G, I-J).

FIG. 2. VPA treatment reduced succinate accumulation in human donor hearts during cold preservation and is associated with increased itaconate availability. (A-G) Metabolite abundance in cold preserved human donor hearts in HTK±VPA without reperfusion at 0 and 8 hours (n=4/group). Abundance was calculated based on one-point calibration using an internal standard control. Data are presented as mean±SD. *P<0.05, and **P<0.01 by Kruskal Wallis test followed by Dunn's multiple comparisons test.

FIG. 3. Increased Irg1 expression contributes to improved cardiac preservation quality and cardiomyocyte (CM) survival following VPA treatment. (A) ChIP-qPCR analysis of H3K27 binding to IRG1 enhancer in human donor heart tissue after 0 and 8 hours cold preservation in HTK±VPA. The occupancy of H3K27ac was normalized to total genomic input DNA and compared to IgG binding (n=4/group). (B) IRG1 mRNA transcript expression in human hearts after preservation with was determined by normalizing to HPRT (n=4/group). (C) Analysis of cardiac contractility (max dP/dt) and (D) relaxation (min dP/dt) during ex-vivo perfusion of murine wild type vs Irg1^{-/-} hearts preserved for 16 hours with or without VPA (n=7-8/group). Left ventricular contractility (max dP/dt) € and relaxation (min dP/dt) (F) of murine donor hearts preserved with HTK±VPA was determined in vivo after transplantation into wild type mice (n=9/group). (G) Representative immunofluorescence staining of fresh frozen sections from mouse left ventricle for sarcomeric α-actinin⁺ cardiomyocytes (red) and TUNEL⁺ cells, (green). DAPI (blue) was used to visualize nuclei. (H) Quantification of data from panel G (n=4/group). Data are presented as mean±SD. *P <0.05, **P<0.0 by Kruskal Wallis test followed by Dunn's multiple comparisons test (A-B, H), one-way ANOVA with Fisher's LSD multiple-comparisons test (C-D) and Student's t test (E-F).

FIG. 4. Irg1 mediates a reduction in oxidative stress and an increase in antioxidant protein expression and activation following VPA administration in mice. (A-B) GSH/GSSG ratios from murine heart tissue preserved for 16 h using HTK solution with or without VPA without reperfusion (A) or followed by sex-matched syngeneic heart transplantation (B) (n=4/group). GSH/GSSG ratio was normalized to amounts in HTK-only preserved hearts. (C) Representative western blots from left ventricles of WT or Irg^{-/-} murine hearts preserved for 16 h using HTK solution with or without VPA followed by ex-vivo perfusion for NRF2, HO1, SOD1 and SOD2. α-tubulin was used for normalization. (D) Quantification of data from panel C (n=5/group). (E) Representative immunofluorescence staining for NRF2 (red) and DAPI (blue) in the left ventricle of ex-vivo perfused WT or Irg^{-/-} murine donor heart preserved for 16 hours with or without VPA. Merged images shown with nuclear translocation of Nrf2 seen in purple (indicated by white arrows). (F) Relative NRF2 fluorescent intensity in nuclear regions. Data are presented as means±SD. Representative images of n=4/group. *P<0.05, **P<0.01 by Student's t test (A-B) or Kruskal Wallis test followed by Dunn's multiple comparisons test (D).

FIG. 5. Treatment with exogenous 4-octyl Itaconate (4-OI) improved cardiac function and increased antioxidant activities in mice. (A) Western blots for NRF2, HO1, SOD1) and α-tubulin (loading control) in murine HL-1 cardiomyocytes with HTK±4-OI under normoxic (20% O₂) or hypoxic (1% O₂) conditions for 2 hours. (B) Quantification of data from panel B (n=6/group) normalized to α-tubulin and compared to control normoxia cells (Ctr). (C-D) Donor mice were treated with 4-OI and the donor hearts were then HTK preserved for 16 hours before evaluation for cardiac contractility (max dP/dt) (C) and relaxation (D) (min dP/dt, n=8/group). (E) Murine donor hearts from panels C-D sectioned to stain for NRF2 (red) and DAPI (blue) using fluorescence microscopy. NRF2 nuclear translocation shown as purple in merged images (indicated by white arrows). (F) Oxidative DNA damage assessed by staining for 8-OHdG fluorescence (red) and DAPI (blue) in left ventricle of donor hearts from mice±4-OI. (G) Quantification of panel F (n=4/group). Data are presented as mean±SD. **P<0.01 by Kruskal Wallis test followed by Dunn's multiple comparisons test (B and G) and Student's t test (C-D, G).

FIG. 6. VPA treatment improved ex-vivo pig heart function and reduced cardiac injury. (A-C) Ex vivo analysis of cardiac function in pig hearts preserved with HTK±VPA treatment for 4 or 10 hours. Hemodynamic measurements recorded in “working” mode at 1 hour of perfusion include (A) contractility (max dP/dt), (B) relaxation (min dP/dt), and (C) cardiac output normalized to heart weight in grams (ml/min/g). In hearts preserved for 4 and 10 hours, multiplex ELISA was used to measure arterial perfusate concentrations of (D) Troponin I (TnI), (E) TNF-α, (F) IL-1B, (G) IL-2 and (H) IL-6 after 3 hours of perfusion (n=8/group). Data are presented as means±SD. *P<0.05, **P<0.01 by one-way ANOVA with Fisher's LSD multiple-comparisons test (A-H).

FIG. 7. VPA administration reduced cell death, oxidative stress and inflammation in ex vivo perfused pig hearts. After 4 or 10 hours of preservation with or without VPA, porcine hearts were perfused ex vivo for 3 hours before analysis. (A) Representative images of 8-OHdG fluorescence (red) to assess for oxidative DNA damage with quantification of staining intensity in (B) (n=4/group). We also stained for (C) NRF2 (red) to determine NRF2 nuclear translocation in the merged images (purple, as indicated by white arrows). Representative images of n=4/group. DAPI (blue) was used to assess nuclei in panels A-C. Western blotting was performed for (D) NRF2, (E) cell death marker cleaved Caspase 3 and (F) pro-survival protein BCL2. Representative blots shown of n=4/group with quantification below by normalization to α-tubulin and standardized to HTK 4 h. (G) Pig heart mRNA transcript expression of IRG1 and inflammatory transcripts IL1B, IL6 and TNFA (n=4/group). Data are presented as mean±SD. *P<0.05, **P<0.01 by Kruskal Wallis test followed by Dunn's multiple comparisons test (B, D-G).

FIG. 8A-E. VPA optimizes murine cardiac preservation and this property is shared by other histone deacetylase inhibitors. (A) Acetylated H3K27 in human donor hearts following cold (4° C.) preservation for 0 and 8 hours with or without VPA treatment. Quantitative H3K27ac values are expressed as a proportion of total H3 histone expression and then normalized to expression values at 0 hour preservation with HTK only (n=4/group). (B) VPA dosages were added to HTK preservation solution at 5, 10 and 20 mM. This was used to preserve murine donor hearts for 16 hours followed by ex-vivo perfusion. Donor heart contractility (max dP/dt) and relaxation (min. dP/dt) were compared to 0 hour preservation control (n=4-5/group). Murine hearts were preserved with other histone deacetylase (HDAC) inhibitors such as SAHA and TSA for 16 hours followed by ex-vivo perfusion. Cardiac (C) contractility (max dP/dt) and (D) relaxation (min dP/dt) were then compared with HTK only controls preserved for 16 hours. (E) An example of LabChart software output showing the ex-vivo hemodynamic performance of murine donor hearts preserved with HTK vs HTK+VPA. Murine aortic perfusion pressure, left ventricular pressure (measured with intracavitary balloon), calculated dP/dt and heart rate are shown. Data are presented as means±SD.*P<0.05, **P<0.01 by one-way ANOVA with Fisher's LSD multiple-comparisons test (A,C, and D) and Student's t test (B).

FIG. 9A-C. VPA administration decreased donor heart production of succinate and augmented itaconate abundance. (A) Graphical depiction of tricarboxylic acid cycle in the context of VPA elevating itaconate abundance to inhibit succinate dehydrogenase and thereby decrease succinate availability during donor heart preservation. Metabolomic analysis of the left ventricle in murine hearts preserved for 16 hours with or without VPA (B) without reperfusion (n=4/group) or (C) followed by sex-matched syngeneic heart transplantation (n=4/group). Metabolite abundance are calculated based on one-point calibration with internal standard control. Data are presented as means±SD. *P<0.05 by Student's t test (B-C).

FIG. 10A-F. HDAC inhibitors induced an increase in Irg1 expression and improved cardiac function, but this was not dependent on myeloid Irg1 expression. (A) Wild type murine donor hearts were preserved for 16 hours with or without HDAC inhibitors (Valproic acid (VPA), suberoylanilide hydroxamic acid (SAHA) or Trichostatin A (TSA)) without reperfusion and analyzed for Irg1 mRNA transcript expression (n=4/group). Results are normalized to HTK only preservation. (B) Murine wild type hearts were preserved for 16 hours with or without HDAC inhibitors followed by ex-vivo perfusion and then determined Irg1 mRNA transcript expression (n=4/group). HTK+VPA was used to preserve wild type murine donor hearts versus hearts with Irg1 deficiency specifically in myeloid cells (LysM^{Cre};Irg1^{f/f}) for 16 hours and then ex-vivo perfused them. Both (C) contractility (max dP/dt) and (D) relaxation (min dP/dt) were determined using a small balloon in the left ventricle (n=4/group). Intravascular HTK was administered to wild type donor hearts and then immediately fresh frozen for left ventricle sectioning (n=8). (D) Pan-leukocyte marker CD45 staining was performed with representative images shown and (E) CD45⁺ cells were enumerated. Cell counts were averaged over 4 high powered fields (HPF) per sample at 20× magnification. Data are presented as means±SD. *P<0.05, **P<0.01 by Kruskal Wallis test followed by Dunn's multiple comparisons test (A-B and F) and Student's t test (C-D).

FIG. 11A-D. Irg1 mediates attenuation of oxidative stress incurred during cold preservation following VPA administration. Murine wild type and Irg1^{-/-} donor hearts were HTK preserved with or without VPA for 16 hours followed by ex-vivo perfusion. The left ventricle was then sectioned for staining with (A) DHE (red) to assess the magnitude of oxidative stress. (B) Overall oxidative stress is quantified by normalization to DAPI (blue) fluorescence intensity. To assess oxidative DNA damage, the same tissue sections were (C) stained for 8-OHdG (red) and (D) quantitative assessments are normalized to DAPI (blue) fluorescence intensity. Representative images shown with corresponding quantitative analysis (n=4/group). Data are presented as means±SD. *P <0.05, **P<0.01 by Kruskal Wallis test followed by Dunn's multiple comparisons test (B and D).

FIG. 12A-B. Treatment with exogenous itaconate (ITA) increased antioxidant expression. (A) Murine HL-1 cardiomyocytes immersed in HTK with or without itaconate (10 mM) were exposed to normoxic (20% O₂) and hypoxic (1% O₂) conditions for 2 hours. Cardiomyocytes were then lysed to undergo western blot for antioxidant protein expression (HO1, SOD1) with α-tubulin loading control. Representative groups are shown in three biological replicates with (B) quantitative graphical representation shown. Data are presented as means±SD. *P<0.05 by Kruskal Wallis test followed by Dunn's multiple comparisons test (B).

FIG. 13A-B. LabChart Software was used to analyze pig heart hemodynamic data. Representative tracings recorded with pressure transducers and conductance catheters from pig hearts preserved with HTK solution with or without VPA are shown. Pig hearts were preserved for (A) 4 or (B) 10 hours followed by ex-vivo perfusion with autologous blood.

FIG. 14A-G. During ex-vivo perfusate of pig donor hearts, electrolyte and arterial 02 saturation concentrations were kept in physiological ranges. Electrolyte content including (A) Calcium; (B) Potassium; (C) Sodium as well as (D) oxygen concentration was kept in physiological ranges. We also measured (D) (E) Lactate trends (n=8-9/group). (F) Oxygen consumption (arterial perfusate minus coronary sinus pO₂, mmHg) shown for pig hearts preserved with HTK with or without VPA for 4 and 10 hours followed by ex-vivo perfusion. Data are presented as means±SD. Statistical analysis by one-way ANOVA with Fisher's LSD multiple-comparisons test (A-F).

FIG. 15. Graphical depiction of exemplary setup for ex-vivo pig heart perfusion apparatus. In resting mode, the left atrium is not loaded and the left atrial pressure remains at 0-1 mmHg. In working mode, the left atrium is loaded up to 15 mmHg via a pump. The aortic root is perfused retrograde at a constant pressure of 80 mmHg and the coronary sinus blood is oxygenated prior to being returned to the aortic root for perfusion.

FIG. 16. Itaconate reduces the doxorubicin-induced cardiotoxicity. 6-week mice were treated with 5 mg/Kg doxorubicin for 5 weeks. Itaconate and 4-OI were I.P. injected every 3.5 days. There are improved ejection fraction, stroke volume, and increased heart and lung weight in itaconate-treated groups compared to saline-treated groups.

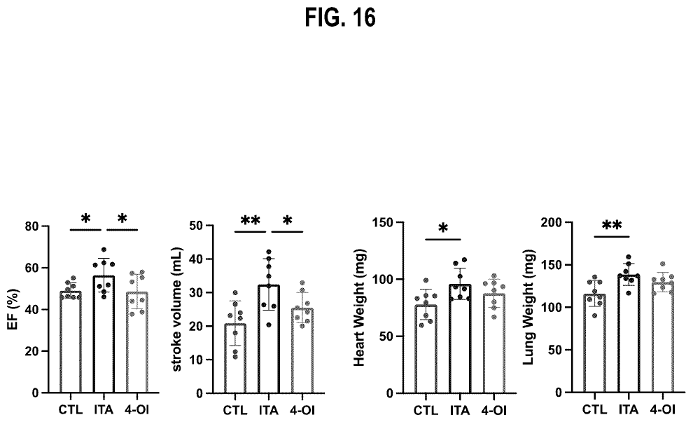

FIG. 17. Itaconate reduces the doxorubicin-induced cardiomyocyte death. 6-week mice were treated with 5 mg/Kg doxorubicin for 5 weeks. Itaconate were I.P. injected every 3.5 days. Itaconate reduced the serum cTnI level, indicating less of cardiomyocyte damage.

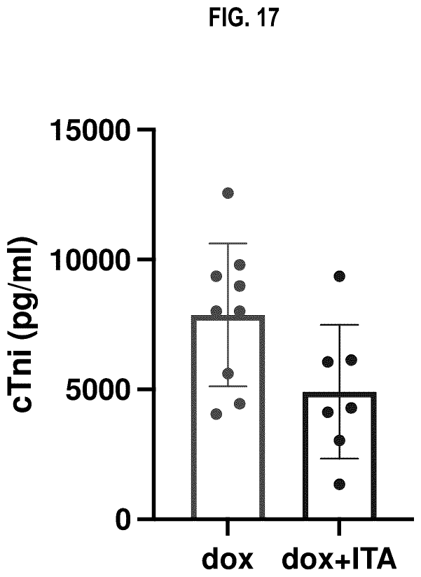

FIG. 18. FIG. 4. Itaconate reduced cardiomyocyte apoptosis. H9C2 cardioblast was treated with 1 μM doxorubicin in the presence of 2 mM itaconate, 10 μM 4-OI for 18 hours. The doxorubicin-induced cell death were evaluated by cleaved caspase 3 using western blot.

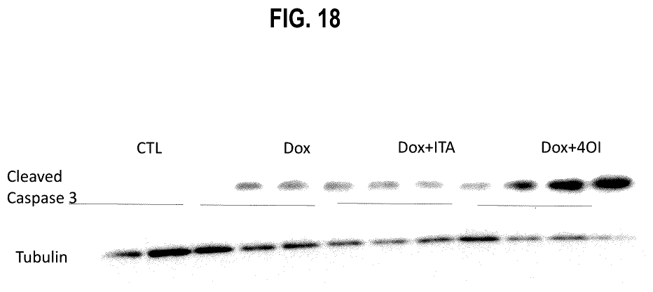

FIG. 19. FIG. 4. Itaconate reduces doxorubicin induced 5 hmC modification. H9C2 cardioblast was treated with 1 μM doxorubicin in the presence of 2 mM itaconate. The 5-hmC level were detected using immunostaining. Doxorubicin treatment induces accumulation of 5-hmC, while itaconate treatment reduce the 5-hmC accumulation.

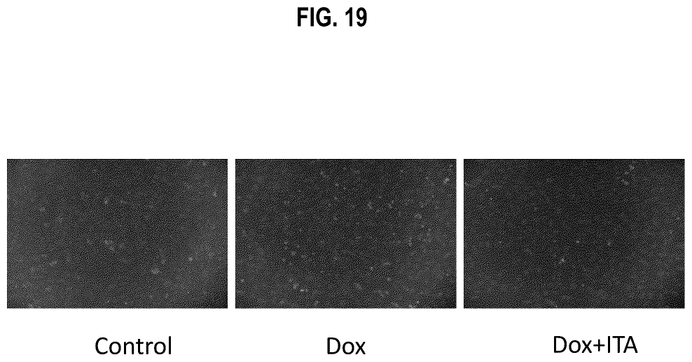

FIG. 20A-G. Treatment with exogenous 4-octyl Itaconate (4-OI) improved cardiac function and increased antioxidant activities in mice. (A) Western blots for NRF2, HO1, SOD1) and α-tubulin (loading control) in murine HL-1 cardiomyocytes with HTK±4-OI under normoxic (20% (2) or hypoxic (1% O₂) conditions for 2 hours. (B) Quantification of data from panel B (n=6/group) normalized to α-tubulin and compared to control normoxia cells (Ctr). (C-D) Donor mice were treated with 4-OI and the donor hearts were then HTK preserved for 16 hours before evaluation for cardiac contractility (max dP/dt) (C) and relaxation (D) (min dP/dt, n=8/group). (E) Murine donor hearts from panels C-D sectioned to stain for NRF2 (red) and DAPI (blue) using fluorescence microscopy. NRF2 nuclear translocation shown as purple in merged images (indicated by white arrows). (F) Oxidative DNA damage assessed by staining for 8-OHdG fluorescence (red) and DAPI (blue) in left ventricle of donor hearts from mice±4-OI. (G) Quantification of panel F (n=4/group). Data are presented as mean±SD. **P<0.01 by Kruskal Wallis test followed by Dunn's multiple comparisons test (B and G) and Student's t test (C-D, G).

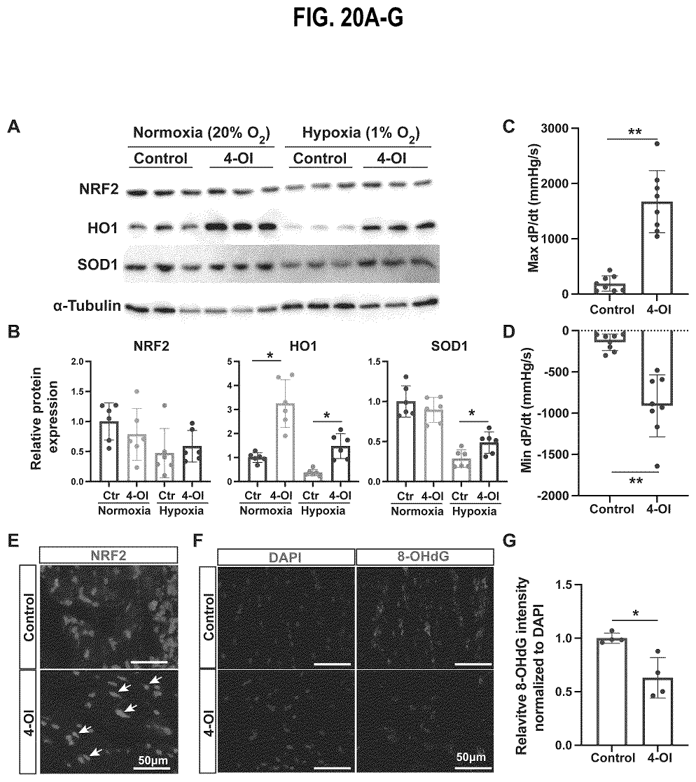

FIG. 21. Itaconate improved murine donor heart function after 16 hours of storage.

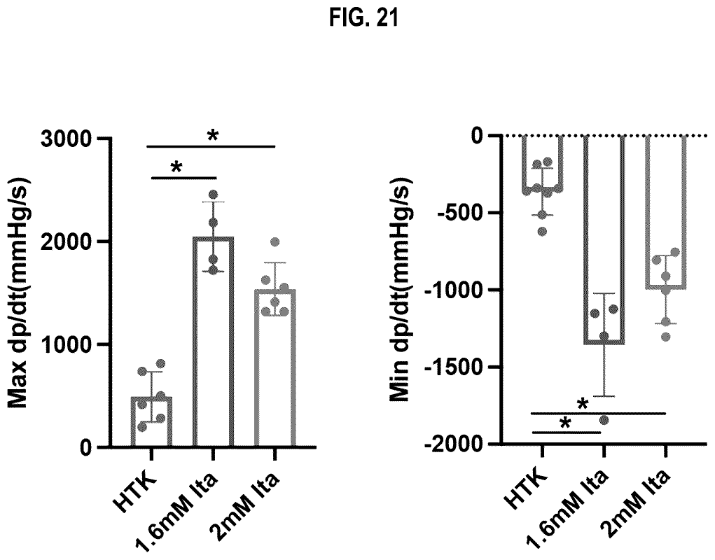

### DEFINITIONS

Although any methods and materials similar or equivalent to those described herein can be used in the practice or testing of embodiments described herein, some preferred methods, compositions, devices, and materials are described herein. However, before the present materials and methods are described, it is to be understood that this invention is not limited to the particular molecules, compositions, methodologies or protocols herein described, as these may vary in accordance with routine experimentation and optimization. It is also to be understood that the terminology used in the description is for the purpose of describing the particular versions or embodiments only, and is not intended to limit the scope of the embodiments described herein.

Unless otherwise defined, all technical and scientific terms used herein have the same meaning as commonly understood by one of ordinary skill in the art to which this invention belongs. However, in case of conflict, the present specification, including definitions, will control. Accordingly, in the context of the embodiments described herein, the following definitions apply.

As used herein and in the appended claims, the singular forms “a”, “an” and “the” include plural reference unless the context clearly dictates otherwise. Thus, for example, reference to “a compound” is a reference to one or more compounds and equivalents thereof known to those skilled in the art, and so forth.

As used herein, the term “and/or” includes any and all combinations of listed items, including any of the listed items individually. For example, “A, B, and/or C” encompasses A, B, C, AB, AC, BC, and ABC, each of which is to be considered separately described by the statement “A, B, and/or C.”

As used herein, the term “comprise” and linguistic variations thereof denote the presence of recited feature(s), element(s), method step(s), etc. without the exclusion of the presence of additional feature(s), element(s), method step(s), etc. Conversely, the term “consisting of” and linguistic variations thereof, denotes the presence of recited feature(s), element(s), method step(s), etc. and excludes any unrecited feature(s), element(s), method step(s), etc., except for ordinarily-associated impurities. The phrase “consisting essentially of” denotes the recited feature(s), element(s), method step(s), etc. and any additional feature(s), element(s), method step(s), etc. that do not materially affect the basic nature of the composition, system, or method. Many embodiments herein are described using open “comprising” language. Such embodiments encompass multiple closed “consisting of” and/or “consisting essentially of” embodiments, which may alternatively be claimed or described using such language.

As used herein, the term “subject” broadly refers to any animal, including human and non-human animals (e.g., dogs, cats, cows, horses, sheep, poultry, fish, crustaceans, etc.). In many embodiments, subjects are mammals, particularly primates, especially humans. In some embodiments, subjects are livestock such as cattle, sheep, goats, cows, swine, and the like; poultry such as chickens, ducks, geese, turkeys, and the like; and domesticated animals particularly pets such as dogs and cats. In some embodiments (e.g., particularly in research contexts) subject mammals will be, for example, rodents (e.g., mice, rats, hamsters), rabbits, primates, or swine such as inbred pigs and the like.

As used herein, the phrase “symptoms are reduced” means when one or more symptoms of a particular disease, disorder or condition is reduced in magnitude (e.g., intensity, severity, etc.) and/or frequency. For purposes of clarity, a delay in the onset of a particular symptom is considered one form of reducing the frequency of that symptom. As used herein, the term “patient” typically refers to a subject that is being treated for a disease or condition.

As used herein, the term “preventing” refers to prophylactic steps taken to reduce the likelihood of a subject (e.g., an at-risk subject) from developing or suffering from a particular disease, disorder, or condition (e.g., asthma). The likelihood of the disease, disorder, or condition occurring in the subject need not be reduced to zero for the preventing to occur; rather, if the steps reduce the risk of a disease, disorder or condition across a population, then the steps prevent the disease, disorder, or condition for an individual subject within the scope and meaning herein.

As used herein, the term “treatment” (also “treat” or “treating”) refer to obtaining a desired pharmacologic and/or physiologic effect against a particular disease, disorder, or condition. Preferably, the effect is therapeutic, i.e., the effect partially or completely alleviates, ameliorates, relives, inhibits, delays onset of, reduces severity of, and/or reduces frequency, incidence or severity of one or more symptoms, features, and/or causes of a particular disease, disorder, and/or condition. Such treatment may be of a subject who does not exhibit signs of the relevant disease, disorder and/or condition and/or of a subject who exhibits only early signs of the disease, disorder, and/or condition. Alternatively or additionally, such treatment may be of a subject who exhibits one or more established signs of the relevant disease, disorder and/or condition. In some embodiments, treatment may be of a subject who has been diagnosed as suffering from the relevant disease, disorder, and/or condition. In some embodiments, treatment may be of a subject known to have one or more susceptibility factors that are statistically correlated with increased risk of development of the relevant disease, disorder, and/or condition.

As used herein, the terms “administration” and “administering” refer to the act of introducing a substance, such as a drug, prodrug, or other agent, or therapeutic treatment to a subject or in vivo, in vitro, or ex vivo cells, tissues, and organs. In general, any route of administration may be utilized including, for example, parenteral (e.g., intravenous), oral, topical, subcutaneous, peritoneal, intra-arterial, inhalation, vaginal, rectal, nasal, introduction into the cerebrospinal fluid, or instillation into body compartments. Exemplary routes of administration to the human body can be by parenteral administration (e.g., intravenously, subcutaneously, etc.), orally, etc.

As used herein, the term “approximately” and “about” is intended to encompass normal statistical variation as would be understood by those of ordinary skill in the art as appropriate to the relevant context. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would 15 exceed 100% of a possible value).

As used herein, the terms “co-administration” and “co-administering” refer to the administration of at least two agent(s) or therapies to a subject. In some embodiments, the co-administration of two or more agents or therapies is concurrent (e.g., in a single formulation/composition or in separate formulations/compositions). In other embodiments, a first agent/therapy is administered prior to a second agent/therapy. Those of skill in the art understand that the formulations and/or routes of administration of the various agents or therapies used may vary. The appropriate dosage for co-administration can be readily determined by one skilled in the art. In some embodiments, when agents or therapies are co-administered, the respective agents or therapies are administered at lower dosages than appropriate for their administration alone. Thus, co-administration is especially desirable in embodiments where the co-administration of the agents or therapies lowers the requisite dosage of a potentially harmful (e.g., toxic) agent(s), and/or when co-administration of two or more agents results in sensitization of a subject to beneficial effects of one of the agents via co-administration of the other agent.

As used herein, the terms “itaconate” and “itaconic acid” refer to a compound of the structure:

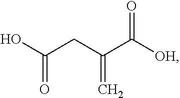

or salts thereof.

As used herein, the terms “itaconate derivative” describes a vinylidene-containing compound, such as alkylitaconic acids and α-methylene-γ-butyrolactones, as described, for example, in Sano et al. Applied Microbiology and Biotechnology (2020) 104:9041-9051; incorporated by reference in its entirety, unless otherwise limited or further defined.

As used herein, the term “pharmaceutical composition” refers to the combination of an active agent with a carrier, inert or active, making the composition especially suitable for diagnostic or therapeutic use in vitro, in vivo or ex vivo.

The term “pharmaceutically acceptable” as used herein, refers to compositions that do not substantially produce adverse reactions, e.g., toxic, allergic, or immunological reactions, when administered to a subject.

As used herein, the term “pharmaceutically acceptable carrier” refers to any of the standard pharmaceutical carriers including, but not limited to, phosphate buffered saline solution, water, emulsions (e.g., such as an oil/water or water/oil emulsions), and various types of wetting agents, any and all solvents, dispersion media, coatings, sodium lauryl sulfate, isotonic and absorption delaying agents, disintigrants (e.g., potato starch or sodium starch glycolate), and the like. The compositions also can include stabilizers and preservatives. For examples of carriers, stabilizers and adjuvants, see, e.g., Martin, Remington's Pharmaceutical Sciences, 15th Ed., Mack Publ. Co., Easton, Pa. (1975), incorporated herein by reference in its entirety.

### DETAILED DESCRIPTION

Provided herein are pharmaceutical compositions and tissue/organ preservation solutions comprising itaconate and/or derivatives thereof and methods of use thereof. In particular, provided herein are compositions comprising itaconate and methods of use thereof for the preservation of tissues/organs for transplantation and treatment/prevention/reduction of conditions such as myocardial infarction, sudden cardiac arrest, stroke, senescence, cardiomyopathies, and cardiotoxicity.

Heart transplant is the gold standard therapy for patients with end stage heart failure because it offers improved quality of life and long-term survival. The contemporary median survival after heart transplantation is about 13-14 years (39). However, demand far outstrips supply. Currently, donor heart preservation techniques are focused on the principles of hypothermia (4), mechanical arrest (4) and more recently, perfusion during transport to minimize ischemic injury. There are no targeted molecular therapies that address specific signaling pathways to improve donor heart preservation and performance after reperfusion. Experiments were conducted during development of embodiments herein to leverage the cardioprotective effects of itaconate to improve donor heart ischemic tolerance and function.

Treatment during preservation greatly improved donor heart function through increasing Irg1 expression and itaconate. Administration of synthetic itaconate derivative (4-OI) was cardioprotective and recapitulated VPA's beneficial effects. This therapeutic mechanism is conserved across murine, pig and human species which has important implications for clinical relevance and subsequent translation.

Cultured cardiomyocytes respond to itaconate derivative (401) administration by increasing antioxidant protein expression and promoting cellular survival. Suppression of inflammation and oxidative injury in native cardiac cells are important for organ preservation biology.

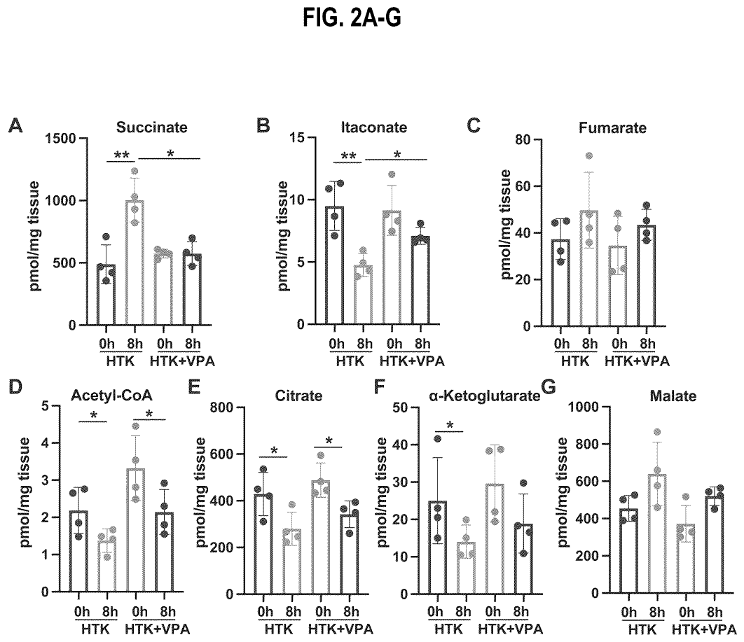

In addition to antioxidant activity, itaconate also plays a critical role in limiting the accumulation of harmful metabolites such as succinate. Itaconate is an inhibitor of succinate dehydrogenase (SDH), which limits the harmful reversal of SDH enzyme activity and increased succinate during ischemia, which is driven by fumarate accumulation. Following reperfusion, this succinate pool is oxidized by mitochondrial mechanisms to generate ROS leading to cardiac injury and dysfunction (FIG. 2) (9, 10). Furthermore, succinate efflux from cells can occur through a monocarboxylate (MCT1) transporter through an associated pH gradient (54). Succinate can then bind to its cognate receptor SUCNR1 on immune cells to further amplify its inflammatory signal (55). In addition to the benefits of itaconate mentioned above, reduced succinate production in donor heart would also be expected to reduce oxidative stress and inflammation within the donor myocardium and downregulate recipient immune cellular responses following reperfusion with transplantation.

Therapeutic strategies that increase itaconate are applicable in a number of clinical settings. In addition to improving cold preservation of donor hearts (and other organs asn tissues), in some embodiments, it is used to minimize cardiac injury in scenarios where the heart has experienced warm ischemic injury. Improved cardiac preservation is also critical in non-transplant cardiac surgery where the heart undergoes cold arrest to perform surgery on components such heart valves, aorta and coronary arteries. The therapeutic potential of utilizing anti-inflammatory metabolic pathways is also likely relevant for preservation of other solid organs for transplantation including lung, liver, kidney. Additionally, modulation of itaconate may be an effective therapeutic strategy for other more common ischemic-reperfusion pathologies such as myocardial infarction, sudden cardiac arrest and stroke.

In some embodiments, provided herein are organ preservation solutions comprising itaconate or an itaconate derivative (e.g., 4-octyl itaconate, dimethyl itaconate, citraconate, etc.). Itaconate and derivatives provide antioxidant activity and limiting the accumulation of harmful metabolites.

In some embodiments, provided herein are compositions (e.g., therapeutics, tissue and/or organ preservation solutions, etc.) comprising itaconate and/or an itaconate derivatives (e.g., 4-octyl itaconate, dimethyl itaconate, citraconate, etc.). Itaconate consists of two carboxy groups and a vinylidene:

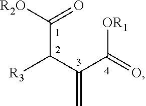

wherein R₁=R₂=R₃=H. Embodiments herein referring to itaconate also encompass salts thereof, unless specified otherwise. All embodiments herein comprising itaconate (and salts thereof) also encompass embodiments comprising only itaconate and not salts thereof. Itaconate derivatives include alkylitaconic acids:

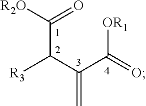

and
α-methylene-γ-butyrolactones (monocyclic or bicyclic):

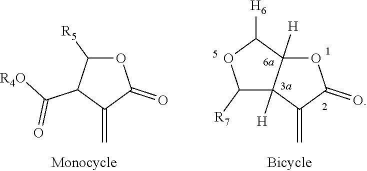

Alkylitaconic acids have a head structure, comprising the itaconate skeleton, and a tail structure, possessing a C4-C18 alkyl chain, and the tail structure is connected to the third carbon of the head structure. Some alkylitaconic acids have alkyl chains that contain an unsaturated bond, hydroxy group, carbonyl group, and/or epoxy group, accounting for the diversity of alkylitaconic acids. In addition, some alkylitaconic acids, such as deoxysporothric acid, possess a ring structure (γ-butyrolactone) that is thought to be formed by dehydration condensation of the carboxy group of the head structure and the hydroxy group of the tail structure.

R1-R7 of the alkylitaconic acid and α-methylene-γ-butyrolactone generic structures above are selected from, for example, any of the substituents of the example derivatives of Sano et al.

α-Methylene-γ-butyrolactones comprise either a monocyclic or bicyclic structure. Example of itaconate derivatives that find use in embodiments herein include alkylitaconic acids, including but not limited to, 3-(Methoxycarbonyl) but-3-enoic acid, Butylitaconic acid, Tensyuic acid A, Hexylitaconic acid, Methyl hexylitaconic acid, Methyl 8-hydroxyhexylitaconic acid, Ethyl 8-hydroxyhexylitaconic acid, 9-Hydroxyhexylitaconic acid, Dimethyl 2-(5-hydroxyhexyl)-3-methylenesuccinic acid, (−)-9-Hydroxyhexylitaconic acid-4-methyl ester, Monomethyl ester of 9-Hydroxyhexylitaconic acid, Ethyl 9-hydroxyhexylitaconic acid, 10-Hydroxyhexylitaconic acid, Asperitaconic acid A, Dimethyl 2-(6-hydroxyhexyl)-3-methylenesuccinic acid, Asperitaconic acid C, Tensyuic acid F, Tensyuic acid B, Octylitaconic acid, Tricladic acid C, Tricladic acid A, Tricladic acid B, Asperitaconic acid B, Talarocyclopenta C, Tensyuic acid C, Tensyuic acid D, Tensyuic acid E, Ceripolic acid A, Ceripolic acid F, Ceripolic acid D, Ceripolic acid E, Ceripolic acid B, α-(15-Hydroxyhexadecyl) itaconic acid, Ceripolic acid C, cis-7-Hexadecenylitaconic acid, Ceriporic acid G, (R)-3-(7,8-Epoxy-hexadecyl)-itaconic acid, Ceripolic acid H, Deoxysporothric acid, Epideoxysporothric acid, and Sporothric acid; monocyclic α-methylene-γ-butyrolactones, including but not limited to, (3S,4R)-3-Carboxy-2-methylene-heptan-4-olide, Methylenolactocin, Nephrosterinic acid, Protolichesterinic acid, Protolichesterinic acid methyl ester, Murolic acid, Protoconstipatic acid, Pertusaric acid, and (−)-Allo-pertusaric acid; and bicyclic α-methylene-γ-butyrolactones, including but not limited to, Xylobovide, Canadensolide, Sporothriolide, Epicthisolide, Ethisolide, Avenaciolide, Isoavenaciolide, and Discosiolide (chemical strcutres of the above exemplary itaconate derivatives are provided in Sano et al. (Applied Microbiology and Biotechnology (2020) 104:9041-9051; incorporated by reference in its entirety).

In some embodiments, tissue and/or organ preservation solutions herein comprise itaconate or an itaconate derivative (e.g., 4-octyl itaconate, dimethyl itaconate, citraconate, etc.) and one or more of a mineralocorticoid receptor antagonist, an aldehyde dehydrogenases agonist, a histone deacetylase inhibitor, and other suitable preservation solution components described herein.

In some embodiments, tissue and/or organ preservation solutions herein comprise itaconate or an itaconate derivative (e.g., 4-octyl itaconate, dimethyl itaconate, citraconate, etc.) and a mineralocorticoid receptor antagonists. Mineralocorticoid receptor antagonists bind to and block the activation of mineralocorticoid receptors by mineralocorticoids such as aldosterone. Examples of mineralocorticoid receptor antagonists that find use in embodiments herein include spironolactone (an aldosterone receptor antagonist used for the treatment of hypertension, hyperaldosteronism, edema due to various conditions, hirsutism (off-label) and hypokalemia), active spironolactone metabolites (e.g., canrenone, etc.), eplerenone (an aldosterone receptor antagonist used to improve survival of patients with symptomatic heart failure and to reduce blood pressure), canrenoic acid (metabolized to canrenone in the body), canrenone, and drospirenone (a progestin used in oral contraceptive pills for the prevention of pregnancy and other conditions).

In some embodiments, tissue and/or organ preservation solutions herein comprise itaconate or an itaconate derivative (e.g., 4-octyl itaconate, dimethyl itaconate, citraconate, etc.) and an aldehyde dehydrogenases agonist. Aldehyde dehydrogenases (ALDHs) are a family of detoxifying enzymes. Aldehyde dehydrogenase activators (Aldas) are a family of small molecule activators of ALDHs, exemplified by lda-1 [N-(1,3-benzodioxol-5-ylmethyl)-2,6-dichlorobenzamide, MW 324]. Alda-1 is an allosteric agonist of ALDH2, and corrects a structural defect in the ALDH2*2 mutant present in 8% of the human population. Alda-89 [5-(2-propenyl)-1,3-benzodioxole, commonly known as safrole, MW=162] is a selective activator of acetaldehyde metabolism by ALDH3A1. Other Aldas that find use in embodiments herein include Alda-52 (1-methoxy-naphthalene-2-carboxylic acid (benzo[1,3] dioxol-5-ylmethyl)-amide), Alda-59 (4-[(benzo[1,3] dioxol-5-ylmethyl)-sulfamoyl]-thiophene-2-carboxylic acid amide), Alda-72 (N-benzo[1,3] dioxol-5-ylmethyl-2-(1-oxo-1,2-dihydro-2,3,9-triaza-fluoren-9-yl)-acetamide), Alda-71 (N-(4-methyl-benzyl)-2-(1-oxo-1,2-dihydro-2,3,9-triaza-fluoren-9-yl)-acetamide), Alda-53 (N-benzo[1,3] dioxol-5-ylmethyl-2-chloro-5-[1,2,4]triazol-4-yl-benzamide), Alda-54 (1-ethyl-4-oxo-1,4-dihydro-chromeno[3,4-d] imidazole-8-sulfonic acid (benzo[1,3] dioxol-5-ylmethyl)-amide), Alda-61 (5-(3,4-dimethyl-isoxazol-5-yl)-2-methyl-N-(4-methyl-benzyl)-benzene sulfonamide), Alda-60 (2-methyl-N-(4-methyl-benzyl)-5-(3-methyl-isoxazol-5-yl)-benzene sulfonamide), Compound Alda-66 (2-(2-isopropyl-3-oxo-2,3-dihydro-imidazo[1,2-c] quinazolin-5-ylsulfanyl)-N-(4-methyl-benzyl)-propionamide), Alda-65 (N-(3,5-dimethyl-phenyl)-2-(2-isopropyl-3-oxo-2,3-dihydro-imidazo[1,2-c] quinazolin-5-ylsulfanyl)-acetamide), Alda-64 (2-(azepane-1-carbonyl)-N-(2-chloro-benzyl)-2,3-dihydro-benzo[1,4]dioxine-6-sulfonamide), Alda-84 (N-(2-hydroxy-phenyl)-3-phenyl-acrylamide), and any other suitable Aldas known in the field, for example, those described in U.S. Pub. No. 2010/0113423; incorporated by reference in its entirety.

In some embodiments, tissue and/or organ preservation solutions herein comprise itaconate or an itaconate derivative (e.g., 4-octyl itaconate, dimethyl itaconate, citraconate, etc.) and a histone deacetylase inhibitor. Histone deacetylase inhibitors (HDAC inhibitors, HDACi, HDIs) are chemical compounds that inhibit histone deacetylases. In some embodiments, a histone deacetylase inhibitor that finds use herein is selective for one or more classes of HDAC (e.g., Class I, Class IIA, Class III, and/or Class IV). In some embodiments, a histone deacetylase inhibitor that finds use herein is a general HDAC inhibitor. The “classical” HDIs act exclusively on Class I, II and Class IV HDACs by binding to the zinc-containing catalytic domain of the HDACs. These classical HDIs are classified into several groupings named according to the chemical moiety that binds to the zinc ion (except cyclic tetrapeptides which bind to the zinc ion with a thiol group). Some examples in decreasing order of the typical zinc binding affinity include: hydroxamic acids (or hydroxamates), such as trichostatin A; cyclic tetrapeptides (such as trapoxin B), and the depsipeptides; benzamides; electrophilic ketones; and aliphatic acid compounds such as phenylbutyrate and valproic acid. “Second-generation” HDIs include the hydroxamic acids vorinostat (SAHA), belinostat (PXD101), LAQ824, and panobinostat (LBH589); and the benzamides entinostat (MS-275), tacedinaline (C1994), and mocetinostat (MGCD0103). The sirtuin Class III HDACs are dependent on NAD+ and are, therefore, inhibited by nicotinamide, as well as derivatives of NAD, dihydrocoumarin, naphthopyranone, and 2-hydroxynaphthaldehydes. Any of the above HDIs may find use in embodiments herein.

In some embodiments, tissue and/or organ preservation solutions herein comprise itaconate or an itaconate derivative (e.g., 4-octyl itaconate, dimethyl itaconate, citraconate, etc.) and valproic acid (VPA) or a valproic acid derivative. VPA is a histone deacetylase inhibitor with potent anti-inflammatory effects. A variety of valproic acid derivatives are well known in the field. Exemplary VPA derivatives include VCD, SPD, and the VPA derivatives depicted in Table 1

TABLE 1
Exemplary Valproic Acid Derivatives.

| | |
|---|---|
| 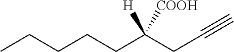 | I |
| S-2-Pentyl-4-pentynoic acid | |
| 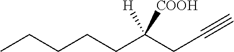 | II |
| R-2-Pentyl-4-pentynoic acid | |
| 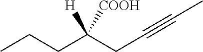 | III |
| S-2-Propyl-4-hexynoic acid | |
| 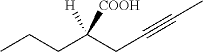 | IV |
| R-2-propyl-4-hexynoic acid | |
| 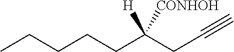 | V |
| S-2-Pentyl-4-pentynoic | |
| hydroxyamic acid | |
| 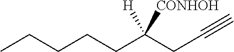 | VI |
| R-2-Pentyl-4-pentynoic acid | |
| hydroxamic acid | |
| 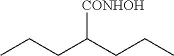 | VII |
| 2-Propyl-pentanoic hydroxamic acid | |
| 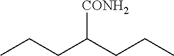 | (VPD) |
| 2-Propyl-pentamide | |
| 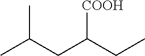 | VIII |
| 2-Ethyl-4-methyl pentanoic acid | |
| 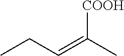 | IX |
| 2-Methyl-2-pentanoic acid | |
| 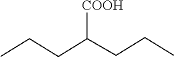 | (VPA) |
| 2-Propyl-pentanoic acid | |

Int'l Patent Application PCT/US2020/33206 (incorporated by reference in its entirety) describes, for example, the use of VPA, derivatives thereof, mineralocorticoid receptor antagonists, histone deacetylase inhibitors, and aldehyde dehydrogenases agonists in the protection of tissues and organs. Any embodiments therein may find use with itaconate and/or itaconate derivatives in the compositions and methods herein.

Experiments conducted during development of embodiments herein demonstrate that itaconate and/or itaconate derivatives provide a protective effect on tissues and organs (e.g., through antioxidant function and/or suppression of harmful metabolites) that can be leveraged to protect organs and tissues for subsequent transplantation and/or in the treatment or prevention of disease. These findings indicate that pre-transplant treatment (e.g., before removal from a subject, during storage or transportation, etc.) of organs such as the heart, lungs, liver, kidney, pancreas, and musculoskeletal structure with a preservation fluid comprising itaconate and/or itaconate derivatives will improvise post-transplant organ function, decreasing rejection and prolonging graft and patient survival. The findings herein also indicate that administration of itaconate and/or itaconate derivatives reduces the risk, severity, and/or likelihood of stroke, cardiac arrest, etc. when administered to a subject.

In some embodiments, provided herein is an organ/tissue preservation fluid comprising a min itaconate and/or itaconate derivatives. In some embodiments, itaconate and/or itaconate derivatives is provided as an additional component of an existing storage or preservation solution. Various existing storage or preservation media may be employed, including but not limited to HTK solution, Celsior solution, Perfadex solution, Perfadex Plus solution, Euro-Collins solution, modified Euro-collins solution, Optisol-GS, K-Sol, McCarey-Kaufman (M-K) solution, Roswell Park Memorial Institute-1,640 solution (RPMI), University of Wisconsin solution and variations thereof.

Euro Collins (EC) solution was designed in the 1960s and considered the preservation solution of choice for over 15 years until organ perseveration was revolutionized by the introduction of University of Wisconsin (UW) solution in 1988 (Mühlbacher et al. Transplant Proc 1999; 31:2069-70; incorporated by reference in its entirety). However, the high molecular weight compounds within UW such as hydroxyethyl starch (HES) resulted in a highly viscous solution that was implicated in part, to organ dysfunction thereby, supporting the development of less vicious alternatives including Celsior (CEL) and histidine-tryptophan-ketoglutarate (HTK) (Feng et al. Hepatobiliary Pancreat Dis Int 2006; 5:490-4; incorporated by reference in its entirety). Many targeted approaches to cardiac organ preservation have been attempted including Plegisol which arose from the initial St. Thomas solution used for cardioplegia, albeit with slight modifications including the addition of a buffering system (Chambers et al. Eur J Cardiothorac Surg 1989; 3:346-52; incorporated by reference in its entirety). In contrast to the aforementioned acellular approaches, Papworth solution was centered on the inclusion of donor blood in its composition (Divisi et al. Eur J Cardiothorac Surg 2001; 19:333-8; incorporated by reference in its entirety).

In some embodiments, appropriate storage or preservation media (for use in conjunction with itaconate and/or itaconate derivatives is selected based on criteria understood by a clinician or transplant technology specialist. In some embodiments, appropriate storage or preservation media (for use in conjunction with itaconate and/or itaconate derivatives) is selected based the type of organ or tissue to be transplanted. For example, Optisol-GS, K-Sol, and McCarey-Kaufman (M-K) solution are understood for use in corneal transplant; therefore, in certain embodiments herein, a preservation fluid is provided comprising (1) itaconate and/or itaconate derivatives and (2) Optisol-GS, K-Sol, or McCarey-Kaufman (M-K) solution (for use in preserving, storing, and/or transplanting cornea). RPMI finds use in skin preservation; as such, in some embodiments, a preservation fluid is provided comprising (1) itaconate and/or itaconate derivatives and (2) RPMI (for use in preserving, storing, and/or transplanting skin). DK solution, Celsior solution, Perfadex solution, Perfadex Plus solution, Euro-Collins solution, modified Euro-collins solution, and UW solution are understood for use in pulmonary and heart transplant; therefore, in certain embodiments herein, a preservation fluid is provided comprising (1) itaconate and/or itaconate derivatives and (2) DK solution, Celsior solution, Perfadex solution, Perfadex Plus solution, Euro-Collins solution, modified Euro-collins solution, or UW solution (for use in preserving, storing, and/or transplanting heart and/or lungs). In some embodiments, (1) itaconate and/or itaconate derivatives and (2) one or more of the preservation solutions described herein find use in the transplant of a tissue or organ that is not traditionally associated with that preservation solution. In some embodiments, (1) itaconate and/or itaconate derivatives and (2) one or more of the preservation solutions described herein find use in the transplant of liver, kidney, etc.

In some embodiments, preservation solutions herein comprise itaconate and/or itaconate derivatives and the components of one or more of HTK solution, Celsior solution, Perfadex solution, Perfadex Plus solution, Euro-Collins solution, modified Euro-collins solution, Optisol-GS, K-Sol, McCarey-Kaufman (M-K) solution, Roswell Park Memorial Institute-1,640 solution (RPMI), University of Wisconsin solution and variations thereof. In other embodiments, provided herein are preservation fluids comprising a itaconate and/or itaconate derivatives and one or more additional components, for example, selected from the components described herein. In some embodiments, provided herein are preservation fluids comprising itaconate and/or itaconate derivatives and a mineralocorticoid receptor antagonist (e.g., spironolactone, canrenone, etc.), aldehyde dehydrogenase agonist (e.g., Alda-1), and/or histone deacetylase inhibitor (e.g., VPA)). In some embodiments, provided herein are preservation fluids comprising itaconate and/or itaconate derivatives and one or more components from one or more of the preservation solutions described herein.

In some embodiments, preservation solutions contain itaconate and/or itaconate derivatives in addition to one or more of monovalent cations (e.g., Na⁺, K⁺, etc.), an impermeant/colloid (e.g., glucose, LactoB, raffinose, mannitol, dextran, albumin, etc.), buffer (e.g., phosphate buffer, bicarbinate, histidine, etc.), antioxidants (e.g., allopurinol (AlloP), glutathione (GSH), tryptophan (Trp), mannitol, etc.), divalent cations (e.g., Ca²⁺, Mg²⁺, etc.), anions (e.g., Cl⁻, OH⁻, SO₄²⁻, etc.), glucose, heparin, dextran, alpha ketoglutarate, etc.

In some embodiments, preservation fluids comprise one or more amino acids (e.g., L-amino acids, D-amino acids, a racemic mixture, standard amino acids, modified amino acids, etc.), an energy source (e.g., adenosine triphosphate (ATP), co-enzyme A, pyruvate, flavin adenine dinucleotide (FAD), thiamine pyrophosphate chloride (co-carboxylase), β-nicotinamide adenine dinucleotide (NAD), β-nicotinamide adenine dinucleotide phosphate (NADPH), nucleosides, nucleotides, phosphate derivatives of nucleosides, etc.), a stimulant (e.g., catecholamines (e.g., epinephrine and/or norepinephrine), vasopressin, Anthropleurin-A and Anthropleurin-B, β1/β2-adrenoreceptor blocking agents, buplinarol, pindolol, alprenolol, cardiac glycosides, etc.), etc.

In certain embodiments, preservation fluids comprise one or more buffers or buffering components. For example, suitable buffer systems include 2-morpholinoethanesulfonic acid monohydrate (MES), cacodylic acid, H₂CO₃/3, citric acid, bis(2-hydroxyethyl)-imino-tris-(hydroxymethyl)-methane (Bis-Tris), N-carbamoylmethylimidino acetic acid (ADA), 3-bis[tris(hydroxymethyl)methylamino]propane (Bis-Tris Propane), piperazine-1,4-bis(2-ethanesulfonic acid) (PIPES), N-(2-Acetamido)-2-aminocthanesulfonic acid (ACES), imidazole, N,N-bis(2-hydroxyethyl)-2-aminoethanesulfonic acid (BES), 3-(N-morpholino) propanesulphonic acid (MOPS), NaH₂PO₄/Na₂HPO₄, N-tris(hydroxymethyl)methyl-2-aminocthanesulfonic acid (TES), N-(2-hydroxyethyl)-piperazine-N′-2-ethanesulfonic acid (HEPES), N-(2-hydroxyethyl) piperazine-N′-(2-hydroxypropanesulfonic acid) (HEPPSO), triethanolamine, N-[tris(hydroxymethyl)methyl]glycine (Tricine), tris hydroxymethylaminoethane (Tris), glycineamide, N,N-bis(2-hydroxyethyl)glycine (Bicine), glycylglycine, N-tris(hydroxymethyl)methyl-3-aminopropanesulfonic acid (TAPS), or a combination thereof. In some embodiments, preservation fluids contain sodium bicarbonate, potassium phosphate, or TRIS buffer.

Preservation fluids may include other components, for example, to help maintain the organ and/or protect it against ischemia, reperfusion injury and other ill effects during perfusion. In certain exemplary embodiments these components may include hormones (e.g., insulin), vitamins, and/or steroids (e.g., dexamethasone and SOLUMEDROL).

In certain embodiments, a blood product is provided with the preservation fluids (e.g., as a component of the preservation fluid, separate from the preservation fluid, etc.). Exemplary suitable blood products may include whole blood, and/or one or more components thereof such as blood serum, plasma, albumin, and red blood cells. In embodiments where whole blood is used, the blood may be passed through a leukocyte and platelet depleting filter to reduce pyrogens, antibodies and/or other items that may cause inflammation in the organ. Thus, in some embodiments, the solution employs whole blood that has been at least partially depleted of leukocytes and/or whole blood that has been at least partially depleted of platelets.

In some embodiments, one or more therapeutics may be included in the preservation fluid, including hormones, such as thyroid hormones (e.g., T3 and/or T4 thyroid hormones), anti-arrhythmic drugs, beta blockers, anti fungals, anti-microbials or anti-biotics (e.g., bacitracin, chlorhexidine, chlorhexidine digluconate, ciprofloxacin, clindamycin, erythromycin, gentamicin, lomefloxacin, metronidazole, minocycline, moxifloxacin, mupirocin, neomycin, ofloxacin, polymyxin B, rifampicin, ruflozacin, tetracycline, tobramycin, triclosan, vancomycin, etc.), anti-inflamatories, anti-proliferatives (e.g., 5-FU, taxol, daunorubicin, mitomycin, etc.), anti-virals (e.g., trifluridine, cidofovir, acyclovir, penciclovir, famciclovir, valcyclovir, gancyclovir, docosanol, etc.), retinoids (e.g., retinol, retinal, isotretinoin, acitretin, adapalene, tazarotene, bexarotene, etc.), NSAIDs (e.g., naproxen, suprofen, ketoprofen, ibuprofen, flurbiprofen, diclofenac, indomethacin, celecoxib, rofecoxib, etc.), vitamin D3 and vitamin D3 analogs (e.g., doxercalciferol, scocalcitol, calcipotriene, tacalcitol, calcitriol, ergocalciferol, calcifediol, etc.), calcium channel blockers, complement neutralizers, ACE inhibitors, immuno-suppressants, steroids (e.g., androgenic and estrogenic steroid hormones, androgen receptor antagonists and 5-α-reductase inhibitors, corticosteroids, alclometasone, clobetasol, fluocinolone, fluocortolone, diflucortolone, fluticasone, halcinonide, mometasone, prednisone, prednisolone, methylprednisolone, triamcinolone, betamethasone, dexamethasone, etc.).

In some embodiments, components of a preservation solution (e.g., each individual component) are present in concentrations between 0.1 and 1000 millimoles (mmol) of component per liter (L) of preservation solution (e.g., 0.1 mmol/L, 0.2 mmol/L, 0.3 mmol/L, 0.4 mmol/L, 0.5 mmol/L, 0.6 mmol/L, 0.7 mmol/L, 0.8 mmol/L, 0.9 mmol/L, 1.0 mmol/L, 2.0 mmol/L, 3.0 mmol/L, 4.0 mmol/L, 5.0 mmol/L, 6.0 mmol/L, 7.0 mmol/L, 8.0 mmol/L, 9.0 mmol/L, 10 mmol/L, 20 mmol/L, 30 mmol/L, 40 mmol/L, 50 mmol/L, 60 mmol/L, 70 mmol/L, 80 mmol/L, 90 mmol/L, 100 mmol/L, 200 mmol/L, 300 mmol/L, 400 mmol/L, 500 mmol/L, 600 mmol/L, 700 mmol/L, 800 mmol/L, 900 mmol/L, 1000 mmol/L, or ranges therebetween). Table 2 sets forth exemplary concentrations for certain exemplary components of a preservation solution. Other components may be present in similar concentrations or other concentrations set forth herein.

TABLE 2
Exemplary components and concentrations for preservation fluid

| | Exemplary |
|---|---|
| Component | concentration |
| Alanine | 1 mg/L-10 g/L |
| Arginine | 1 mg/L-10 g/L |
| Asparagine | 1 mg/L-10 g/L |
| Aspartic Acid | 1 mg/L-10 g/L |
| Cysteine | 1 mg/L-10 g/L |
| Cystine | 1 mg/L-10 g/L |
| Glutamic Acid | 1 mg/L-10 g/L |
| Glutamine | 1 mg/L-10 g/L |
| Glycine | 1 mg/L-10 g/L |
| Histidine | 1 mg/L-10 g/L |
| Hydroxyproline | 1 mg/L-10 g/L |
| Isoleucine | 1 mg/L-10 g/L |
| Leucine | 1 mg/L-10 g/L |
| Lysine | 1 mg/L-10 g/L |
| Methionine | 1 mg/L-10 g/L |
| Phenylalanine | 1 mg/L-10 g/L |
| Proline | 1 mg/L-10 g/L |
| Serine | 1 mg/L-10 g/L |
| Threonine | 1 mg/L-10 g/L |
| Tryptophan | 1 mg/L-10 g/L |
| Tyrosine | 1 mg/L-10 g/L |
| Valine | 1 mg/L-10 g/L |
| Adenine | 1 mg/L-10 g/L |
| ATP | 10 ug/L-100 g/L |
| Adenylic Acid | 10 ug/L-100 g/L |
| ADP | 10 ug/L-100 g/L |
| AMP | 10 ug/L-100 g/L |
| Ascorbic Acid | 1 ug/L-10 g/L |
| D-Biotin | 1 ug/L-10 g/L |
| Vitamin D-12 | 1 ug/L-10 g/L |
| Cholesterol | 1 ug/L-10 g/L |
| Dextrose (Glucose) | 1 g/L-150 g/L |
| Multi-vitamin Adult | 1 mg/L-20 mg/L or |
| Epinephrine | 1 ug/L-1 g/L |
| Folic Acid | 1 ug/L-10 g/L |
| Glutathione | 1 ug/L-10 g/L |
| Guanine | 1 ug/L-10 g/L |
| Inositol | 1 g/L-100 g/L |
| Riboflavin | 1 ug/L-10 g/L |
| Ribose | 1 ug/L-10 g/L |
| Thiamine | 1 mg/L-10 g/L |
| Uracil | 1 mg/L-10 g/L |
| Calcium Chloride | 1 mg/L-100 g/L |
| NaHCO3 | 1 mg/L-100 g/L |
| Magnesium sulfate | 1 mg/L-100 g/L |
| Potassium chloride | 1 mg/L-100 g/L |
| Sodium glycerophosphate | 1 mg/L-100 g/L |
| Sodium Chloride | 1 mg/L-100 g/L |
| Sodium Phosphate | 1 mg/L-100 g/L |
| Insulin | 1 IU-150 IU |
| Serum albumin | 1 g/L-100 g/L |
| Pyruvate | 1 mg/L-100 g/L |
| Coenzyme A | 1 ug/L-10 g/L |
| Serum | 1 ml/L-100 ml/L |
| Heparin | 500 U/L-1500 U/L |
| Solumedrol | 200 mg/L-500 mg/L |
| Dexamethasone | 1 mg/L-1 g/L |
| FAD | 1 ug/L-10 g/L |
| NADP | 1 ug/L-10 g/L |
| adenosine | 1 mg/L-10 g/L |
| guanosine | 1 mg/L-10 g/L |
| GTP | 10 ug/L-100 g/L |
| Component | Solution |
| GDP | 10 ug/L-100 g/L |
| GMP | 10 ug/L-100 g/L |

In some embodiments, a preservation fluid is provided at the proper concentration for administration to a tissue or organ. In other embodiments, a concentrated preservation fluid is provided (e.g., 2×, 3×, 4×, 5×, 6×, 7×, 8×, 9×, 10×, 15×, 20×, 50×, 100×, or more, or ranges therebetween), and the concentrated preservation fluid is diluted to an appropriate concentration for administration prior to use. In some embodiments, a preservation fluid is provided as two or more separate compositions (e.g., fluids, dried reagents, etc.) that are combined (e.g., with mixing) prior to administration. In some embodiments, a preservation fluid is provided as a dried reagent that is dissolved in solution (e.g., water, buffer, etc.) prior to use.

In certain embodiments, a preservation fluid is provided in the form of a kit that includes. An exemplary kit may include components identified above in one or more fluid solutions for use in an organ perfusion. In certain embodiments, the kit may include multiple solutions, such as a preservation fluid, a nutritional solution, a supplemental composition or solution, etc., or may include dry components that may be regenerated in a fluid to form one or more solutions. A kit may also comprise components from the solutions in one or more concentrated solutions which, on dilution, provide a preservation, nutritional, and/or supplemental solution as described herein. The kit may also include a priming solution.

In certain embodiments, the kit is provided in a single package, wherein the kit includes one or more solutions (or components necessary to formulate the one or more solutions by mixing with an appropriate fluid), and instructions for sterilization, flow and temperature control during perfusion and use and other information necessary or appropriate to apply the kit for perfusion. In certain embodiments, a kit is provided with only a single solution and a set of instructions and other information or materials necessary or useful to operate the solution.

In some embodiments, the preservation fluid or kit is provided with devices, instruments, materials (e.g., tubing, syringe, bags, etc.) for administering the fluid to an organ or tissue.

In some embodiments, methods are provided herein for preserving and/or storing an organ/tissue using the preservation fluids described herein. In some embodiments, a preservation fluid is administered to a tissue/organ by a clinician or other medical operator. In some embodiments, the organ/tissue is perfused with the preservation fluid. In some embodiments, a system is provided for perfusing an organ with the preservation fluid. In some embodiments, the system comprises one or more tubes, conduits, channels, etc. for delivering the preservation fluid to the organ/tissue. In some embodiments, the system comprises one or more tubes, conduits, channels, etc. for receiving the preservation fluid from the organ/tissue. In some embodiments, the system comprises a pump, syringe, or other mechanism for generating the flow of the preservation fluid.

In some embodiments, a tissue/organ is removed from the donor, and is subsequently exposed to the preservation fluid (e.g., perfused with). In some embodiments, a tissue/organ is exposed to the preservation fluid (e.g., perfused with) prior to being removed (e.g., fully removed) from the donor.

In some embodiments, preservation fluid is left in the tissue/organ (or vasculature thereof) for transport/storage of the tissue/organ. Following treatment with the preservation fluid, the tissue/organ is stored for a time period before being transplanted into a recipient. In some embodiments, the tissue/organ is transported during the storage time. In some embodiments, a time period of 5 minutes to 6 months (e.g., 5 minutes, 10 minutes, 30 minutes, 1 hour, 2 hours, 4 hours, 6 hours, 12 hours, 24 hours, 2 days, 3 days, 4 days, 7 days, 14 days, 30 days, 2 months, 4 months, 6 months, or more or ranges therebetween) elapses between removing the organ/tissue from the donor and transplanting the organ/tissue into the recipient.

In some embodiments, during storage/transport, the organ is maintained at a specific temperature (e.g., between −20° C. and 20° C. (e.g., −20° C., −18° C., −16° C., −14° C., −12° C., −10° C., −8° C., −6° C., −4° C., −2° C., 0° C., 2° C., 4° C., 6° C., 8° C., 10° C., 12° C., 14° C., 16° C., 18° C., 20° C., or ranges therebetween)).

In some embodiments, itaconate and/or itaconate derivatives are provided as a prophylactic and/or therapeutic pharmaceutical compositions for the treatment and/or prevention of organ injury (e.g., as a result of cardiac arrest, stroke, etc.).

In some embodiments, itaconate and/or itaconate derivatives are provided (e.g., co-administered and/or co-formulated) with one or more histone acetylation code drugs and method of use thereof to treat and/or prevent organ (e.g., heart) damage. Compositions and methods are described, for example, in International App. No. PCT/US2021/39650 (incorporated by reference in its entirety) that may find use in embodiments herein in combination with itaconate and/or itaconate derivatives.

Itaconate and/or itaconate derivatives may be administered (alone or co-administered with other agent(s)) therapeutically/prophylactically for the treatment/prevention of injury/damage to any tissue, organ, system, etc. and as a result of any condition, disease, or event. For example, the subject may suffer from (or have suffered) or be at risk of disorder/event of the cardiovascular system, the digestive system, the endocrine system, the excretory system, the lymphatic system, the integumentary system, the muscular system, the nervous system, the reproductive system, the respiratory system, and/or the skeletal system. In some embodiments, the disorder/event may be of the heart, salivary glands, esophagus, stomach, liver, gallbladder, pancreas, intestines, colon, rectum, anus, endocrine glands (such as the hypothalamus, pituitary gland, pineal body, thyroid, parathyroid, adrenal glands), kidneys, ureters, bladder, urethra, lymph nodes, tonsils, adenoids, thymus, spleen, skin, muscles, brain, spinal cord, ovaries, fallopian tubes, uterus, vulva, vagina, testes, vas deferens, seminal vesicles, prostate, penis, pharynx, larynx, trachea, bronchi, lungs, diaphragm, cartilage, one or more ligaments, one or more nerves, or one or more tendons of the subject. In particular embodiments, the disorder/event is of the cardiovascular system and the drug combination is administered to treat or prevent myocardial damage. However Itaconate and/or itaconate derivatives may be administered or co-administered in response to a kidney disorder/event (e.g. chronic kidney disease, polycystic kidney disease, etc.), a liver disorder/event (e.g. inherited metabolic defects, chronic viral hepatitis, liver cirrhosis, primary or metastatic liver cancer, etc.), cancer, etc.

Exemplary cardiovascular/cardiac disorders/events for which Itaconate and/or itaconate derivatives are administered/co-administered are selected from the list of aortic dissection, cardiac arrhythmia (e.g. atrial cardiac arrhythmia (e.g. premature atrial contractions, wandering atrial pacemaker, multifocal atrial tachycardia, atrial flutter, atrial fibrillation, etc.), junctional arrhythmias (e.g. supraventricular tachycardia, AV nodal reentrant tachycardia, paroxysmal supra-ventricular tachycardia, junctional rhythm, junctional tachycardia, premature junctional complex, etc.), atrio-ventricular arrhythmias, ventricular arrhythmias (e.g. premature ventricular contractions, accelerated idioventricular rhythm, monomorphic ventricular tachycardia, polymorphic ventricular tachycardia, ventricular fibrillation, etc.), congenital heart disease, myocardial infarction, dilated cardiomyopathy, hypertrophic cardiomyopathy, aortic regurgitation, aortic stenosis, mitral regurgitation, mitral stenosis, Ellis-van Creveld syndrome, familial hypertrophic cardiomyopathy, Holt-Orams Syndrome, Marfan Syndrome, Ward-Romano Syndrome, and/or similar diseases and conditions.

In some embodiments, routes of administration, formulations, and the pharmaceutical composition are selected to provide efficient and effective delivery. In some embodiments, Itaconate and/or itaconate derivatives are provided in pharmaceutical formulations for administration to a subject by a suitable route. The pharmaceutical formulations described herein can be administered to a subject by multiple administration routes, including but not limited to, oral, parenteral (e.g., intravenous, subcutaneous, intramuscular), intranasal, buccal, topical, rectal, or transdermal administration routes. Moreover, the pharmaceutical compositions described herein (e.g., comprising itaconate and/or itaconate derivatives) are formulated into any suitable dosage form, including but not limited to, aqueous oral dispersions, liquids, gels, syrups, elixirs, slurries, suspensions, aerosols, fast melt formulations, effervescent formulations, lyophilized formulations, tablets, powders, pills, dragees, and capsules.

One may administer the itaconate and/or itaconate derivatives in a local rather than systemic manner, for example, via injection of the compound directly into an organ or tissue, often in a depot preparation or sustained release formulation. Such long-acting formulations may be administered by implantation (for example subcutaneously or intramuscularly) or by intramuscular injection. Furthermore, one may administer the drug(s) in a targeted drug delivery system, for example, in a liposome coated with organ-specific antibody. The liposomes will be targeted to and taken up selectively by the organ. In addition, the drug(s) may be provided in the form of a rapid release formulation, in the form of an extended-release formulation, or in the form of an intermediate release formulation.

Determination of effective amounts (e.g., of itaconate and/or itaconate derivatives) may involve in vitro assays in which varying doses of agent are administered to cells in culture and the concentration of agent effective for ameliorating some or all symptoms is determined in order to calculate the concentration required in vivo. Effective amounts may also be based in in vivo animal studies.

Pharmaceutical compositions (e.g., comprising itaconate and/or itaconate derivatives) may be in unit dosage forms suitable for single administration of precise dosages. In unit dosage form, the formulation is divided into unit doses containing appropriate quantities of one or more agents therapeutically/prophylactically.

Dosing and administration regimes are tailored by the clinician, or others skilled in the pharmacological arts, based upon well-known pharmacological and therapeutic considerations including, but not limited to, the desired level of therapeutic effect, and the practical level of therapeutic effect obtainable.

In some embodiments, and upon the clinician's discretion, the administration of the itaconate and/or itaconate derivatives may be administered for an extended period of time, including throughout the duration of the patient's life in order to treat the disorder or ameliorate or otherwise control or limit the symptoms of the patient's disease.

In a case wherein the patient's status does improve, upon the clinician's discretion the administration of the agents (e.g., itaconate and/or itaconate derivatives) may be given continuously; alternatively, the dose of drug being administered may be temporarily reduced or temporarily suspended for a certain length of time (i.e., a “drug holiday”). The length of the drug holiday can vary between 2 days and 1 year, including by way of example only, 2 days, 3 days, 4 days, 5 days, 6 days, 7 days, 10 days, 12 days, 15 days, 20 days, 28 days, 35 days, 50 days, 70 days, 100 days, 120 days, 150 days, 180 days, 200 days, 250 days, 280 days, 300 days, 320 days, 350 days, or 365 days. The dose reduction during a drug holiday may be from about 10% to about 100%, including, by way of example only, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100%.

In some embodiments, once improvement of the patient's symptoms/disorder/condition has occurred, a maintenance dose is administered if necessary. Subsequently, the dosage or the frequency of administration, or both, can be reduced, as a function of the symptoms, to a level at which the improved disease, disorder or condition is retained. Patients can, however, require intermittent treatment on a long-term basis upon any recurrence of symptoms.

In some embodiments, the amount of a given agent that will correspond to such an amount will vary depending upon factors such as the particular compound, disease and its severity, the identity (e.g., weight) of the subject or host in need of treatment, but can nevertheless be determined in a manner recognized in the field according to the particular circumstances surrounding the case, including, e.g., the specific agent being administered, the route of administration, the condition being treated, and the subject or host being treated. In general, however, doses employed for adult human treatment will typically be in the range of about 0.02-about 5000 mg per day, in some embodiments, about 1-about 1500 mg per day. The desired dose may conveniently be presented in a single dose or as divided doses administered simultaneously (or over a short period of time) or at appropriate intervals, for example as two, three, four or more sub-doses per day.

Provided in certain embodiments herein are combination therapies in which itaconate and/or itaconate derivatives provided herein are co-administered with one or more additional agents for the treatment of the disorder/condition, a side effect of the primary agent, or a comorbidity of the disorder/condition. Co-administered agents do not have to be administered in the same pharmaceutical composition, and may, because of different physical and chemical characteristics, have to be administered by different routes. Co-administered agents may be administered concurrently (in the same or separate formulations/compositions) or at separate times (separated by minutes, hours, days, etc.) The co-administered agents may be administered concurrently (e.g., simultaneously, essentially simultaneously or within the same treatment protocol) or sequentially, depending upon the nature of the disease, disorder, or condition, the condition of the patient, and the actual choice of agent used. The determination of the order of administration, and the number of repetitions of administration of each therapeutic agent during a treatment protocol, is well within the knowledge of the clinician after evaluation of the disease being treated and the condition of the patient.

Therapeutically-effective dosages can vary when the drugs are used in treatment combinations. Methods for experimentally determining therapeutically-effective dosages of drugs and other agents for use in combination treatment regimens are described in the literature. For example, the use of metronomic dosing, i.e., providing more frequent, lower doses in order to minimize toxic side effects, has been described extensively in the literature. Combination treatment further includes periodic treatments that start and stop at various times to assist with the clinical management of the patient.

For combination therapies described herein, dosages of the co-administered agents will of course vary depending on the type of co-drug employed, on the specific drug employed, on the disease being treated and so forth. In addition, when co-administered with one or more biologically active agents, the compound provided herein may be administered either simultaneously with the biologically active agent(s), or sequentially.

In some embodiments, itaconate and/or itaconate derivatives are administered to reduce cardiotoxicity in a subject in need thereof. In some embodiments, the subject suffers from drug-induced cardiotoxicity. In some embodiments, the subject has been administered a chemotherapeutic. In some embodiments, itaconate and/or itaconate derivatives are co-administered with a chemotherapeutic (e.g., to reduce cardiotoxicity). Chemotherapies for use with itaconate and/or itaconate derivatives include all classes of chemotherapeutic agents, such as, alkylating agents, antimetabalites, plant alkaloids, antibiotics, hormonal agents, and miscellaneous anticancer drugs. Specific agents include, for example, abraxane, altretamine, docetaxel, herceptin, methotrexate, novantrone, zoladex, cisplatin (CDDP), carboplatin, procarbazine, mechlorethamine, cyclophosphamide, camptothecin, ifosfamide, melphalan, chlorambucil, busulfan, nitrosurea, dactinomycin, daunorubicin, doxorubicin, bleomycin, plicomycin, mitomycin, etoposide (VP16), tamoxifen, raloxifene, estrogen receptor binding agents, taxol, gemcitabine, fuldarabine, navelbine, farnesyl-protein tansferase inhibitors, transplatinum, 5-fluorouracil, vincristin, and vinblastin, or any analog or derivative variant of the foregoing and also combinations thereof. In some embodiments, chemotherapy is employed before, during and/or after administration of itaconate and/or itaconate derivatives.

In some embodiments, itaconate and/or itaconate derivatives are administered to a subject to slow or reverse aging (e.g., cardiovascular aging, cellular senescence, etc.).

### EXPERIMENTAL

### Materials and Methods

### Study Design Paragraph

Experiments were conducted during development of embodiments herein to improve donor heart preservation quality by modulating histone acetylation. The mechanism of this effect acts through increased expression of the cardioprotective Irg1 enzyme as determined by pharmacological and genetic mouse models. HTK preservation solution with or without pharmacological HDAC inhibitors (VPA, SAHA, TSA) were administered to WT (C57BL/6J) hearts. These were preserved for 16 hours and then ex-vivo perfused in Krebs buffer followed by hemodynamic assessment. Cardiac function after VPA treatment was also assessed in-vivo in a heterotopic cervical heart transplant model at 24 hours after transplantation. Metabolomic analysis was used to identify metabolites. Irg14-mice on a C57BL/6J background were used to determine the mechanism of VPA's cardioprotective effects. Porcine hearts were procured from 40-50 kg Yorkshire pigs and preserved with HTK solution with or without VPA for 4 or 10 hours. Ex-vivo heart perfusion with donor blood was then performed. Porcine heart performance was assessed with a Miller conductance catheter. PCR, immunohistochemistry and TUNEL staining were performed per manufacturer's instructions. All animal studies were approved by the University of Michigan Animal Care and Use Committee and conducted in compliance with the relevant institutional state and federal regulations. Human donor heart studies were approved by the University of Michigan Institutional Review Board (HUM00131275). Animals and human donors were randomly assigned to treatment groups for the studies with analysis done in a blinded fashion. Technical issues such as cannula dislodgement during ex vivo perfusion, air embolism or surgical injury to the heart lead to the sample being excluded.

### Animals

Mice: All animal experiments were approved by the Institutional Animal Care and Use Committee at the University of Michigan-Ann Arbor (PRO00010630). Both male and female wild type C57BL/6J (stock number 000664) and Irg1^{-/-} mice (stock number 029340) on a C57BL/6J background were obtained from the Jackson Laboratories.

Genotyping primers for Irg1^{-/-} were: common: GTG GGG AGG GGA ACT ATG AG; Wild Type reverse: ATT TGG AGG AAC CCC ATG AC; Mutant Reverse: CAG CCT CTA AGC CAG ACA GC.

Pigs: All the pig experiments were approved by the Institutional Animal Care and Use Committee at the University of Michigan-Ann Arbor (PRO00009611). Male and female Yorkshire pigs weighing 40-50 kg were purchased from the South Campus Animal Farms of the Michigan State University.

### Procurement and Preparation of Human and Pig Heart Tissue

Heart procurement for both human and pigs were performed as follows. A sternotomy is performed under general anesthesia. The pericardium is then opened to create a pericardial cradle for the heart. Heparin (300U/kg) administered through the right atrium or in a peripheral vein. After waiting 3 minute for adequate anticoagulation from heparin, a 9 Fr antegrade plegia infusion catheter is placed in the ascending aorta. Approximately 1 liter of autologous donor arterial blood is then collected into a collection bottle containing heparin. The human or pig donor heart is then retrieved per clinical protocol by incising the inferior vena cava to drain the right heart and then the left atrial appendage is incised to drain the left heart. Subsequently, the ascending aorta is cross-clamped distal to the cardioplegia catheter and 1 liter of cold (4° C.) HTK solution is infused into the coronaries at a perfusion pressure of ˜80 mmHg to induce mechanical arrest. After excising the heart completely, it is transported to the back-table for infusion of 2 liters of HTK±VPA solution. After completion, the heart is stored in a solution identical to the perfusate at 4° C. on ice.

Pig hearts underwent ex-vivo perfusion after preservation for 4 or 10 hours. Approval for human heart procurement was obtained from the University of Michigan Institutional Review Board (HUM00131275). Human donor hearts from deceased brain death donors were procured as per standard clinical protocols from the Gift of Life Michigan (GOLM) organ procurement facility. Myocardial biopsies (˜5 mm³) of LV were biopsied immediately after cardioplegic arrest (0 h) and after 8 hours (8 h) of cold storage in a cooler containing ice. The eight human donors had an average age of 47.9±16.3 years. Causes of death were stroke (n=4), trauma (n=2), drug overdose (n=1), and cardiac arrest (n=1). Heart tissue were either fixed in formalin or snap frozen in liquid N₂ for later analysis.

### Cardiac Function Experiments

### Murine Ex-Vivo Heart Perfusion

Male and female WT or Irg1^{-/-} mice (Jackson laboratories, Bar Harbor, ME) were anesthetized intraperitoneally with 80 mg/kg ketamine and 5 mg/kg xylazine, anticoagulated with heparin (2,000 U/kg iv), and the heart was rapidly exposed through a sternal incision. The aorta was cannulated and retrograde perfused in-situ with HTK solution±HDAC inhibitors. After cannulation, the heart dissected free, the left atrium was opened. For 4-OI (Cayman Chemical, 25374) experiments, donor mice were treated 4-OI (dissolved in 40% β-Cyclodextrin, 50 mg/kg intraperitoneally) or vehicle control (40% β-Cyclodextrin intraperitoneally) 2 hours prior to donor heart procurement. After dissection, the heart was stored at 4° C. with HTK or HTK with VPA for a pre-designated duration. The hearts were then mounted on a Radnoti mouse Langendorff apparatus (ADInstruments inc., Colorado Springs, CO) in constant-pressure mode (˜70 mmHg) with a modified Krebs-Henseleit buffer (KHB; in mM: 118 NaCl, 4.7 KCl, 1.25 CaCl₂), 1.66 MgSO₄, 24.88 NaHCO₃, 1.18 KH2PO4, 5.55 glucose, and 2.0 Na-pyruvate). A balloon was placed in the LV through the left atrium and left ventricular diastolic pressure was set to ˜8 mmHg at initiation. The heart was perfused with modified Krebs-Henseleit buffer for 30 min to stabilize and then hemodynamics measurements were recorded. Myocardial temperature was maintained at 37° C. LabChart software (ADInstruments inc., Colorado Springs, CO) was used to record ventricular function, perfusion pressures, cardiac chamber temperature and myocardial temperature. After perfusing the heart for 60 minutes, the heart was removed from the ex-vivo perfusion apparatus for specimen collection. Tissue was immediately placed in liquid N₂ or treated with 4% formalin.

### Murine Heterotopic Heart Transplantation

Cardiac grafts procured from WT C57Bl/6J mice following arrest with cold (4° C.) HTK±VPA were transplanted into the right neck of sex-matched syngeneic C57BL/6J recipient mice following 16 hours of cold (4° C.) preservation in corresponding HTK±VPA solution as previously described (59). A cuff technique was used to connect the recipient right common carotid artery and right external jugular vein to the donor ascending aorta and pulmonary artery, respectively. Following reperfusion in the recipient, successful grafts were expected to resume a regular heartbeat. At 24 hours after reperfusion, the surgical incision was reopened and a small conductance catheter was introduced into the LV to measure contractility and relaxation.

### Porcine Ex-Vivo Heart Perfusion

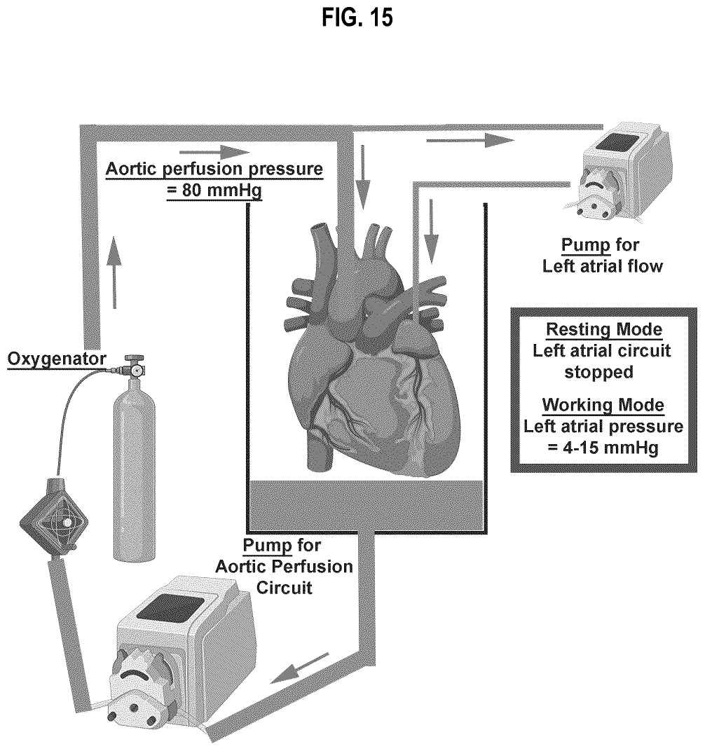

For ex-vivo pig heart perfusion (FIG. 15), the ascending aorta is connected to the arterial perfusion cannula and the left atrium is closed by suturing shut the pulmonary veins. A pressure monitoring catheter and left atrial infusion catheter were then placed into the left atrial cavity and secured. The Miller conductance catheter was introduced into the left ventricular cavity for measurement of ventricular performance parameters. The Radnoti constant perfusion pressure apparatus (ADInstruments Inc., Colorado Springs, CO) was utilized for ex-vivo large animal heart perfusion. Approximately 1 liter of previously collected autologous blood was added to ˜3.5 liters of Krebs buffer and this was initially infused at 24° C. with gradual warming to 37° C. After air was removed from the perfusion system, the ascending aorta and coronaries were retrograde perfused through the arterial cannula at physiological pressure ˜80 mmHg, leading to cardiac reanimation. The perfusion pressure was kept constant at ˜80 mmHg so LV contraction would need to overcome this afterload for cardiac output. Shockable arrhythmias such as ventricular tachycardia, ventricular fibrillation, supraventricular tachycardia were electrically cardioverted to sinus rhythm by delivery of 10 or 20 joules of energy. Cardiac performance was assessed in “resting” and “working” modes (60, 61). The left atrial pressure in resting mode was typically 0-1 mmHg. To assess cardiac hemodynamics in “working mode”, perfusate was infused into the left atrium at 4-10 mmHg at the 4-hour time point for LV loading and cardiac output assessment. Because cardiac performance was highly impaired as expected at the 10-hour time point, the left atrium was loaded to a pressure of up to 15 mmHg to assess cardiac output. At 1 hour intervals, both arterial perfusate and coronary sinus blood were collected for monitoring and analysis. Oxygen pressure was kept at about pO₂ 150-200 mmHg while pCO2 was kept at about 35-40 mmHg. Arterial pH was maintained at 7.35-7.40 by buffering with 5% CO₂ during gas exchange. The heart was perfused ex vivo for 3 hours and then arrested with 4° C. HTK solution for specimen collection in formalin or snap frozen with liquid N₂. The heart was weighed at the time of procurement and at the end of perfusion.

### Mass Spectrometry Metabolomics Analysis

Metabolomics measurements were performed by the Michigan Regional Comprehensive Metabolomics Resource Core (Ann Arbor, MI, USA).

### Single-Cell Analysis of Adult Human Hearts

The single-cell RNA-seq data from Litviňuková et al³⁰ was downloaded to evaluate the expression of IRG1 in different cell types in the adult human heart (62).

### Mouse Serum Assay and Pig Perfusate Assay

Blood from recipient mice was centrifuged at 3000 g in 4° C. for 10 minutes. Serum was aliquoted and snap-frozen. Serum cTnT, cTnI, TNFα, IL-6, IP10 and MIG concentrations were measured using Sigma-Aldrich MILLIPLEX kits (Cat. No.: MCYTMAG, MCVD2MAG). Pig arterial perfusate was centrifuged at 3000 g in 4° C. for 10 minutes. The abundance of cTnI, IL-1β, IL-6 and TNF-α was detected using Sigma MILLIPLEX kit (Cat. No.: MCVD2MAG, PCYTMAG).

### Cell Culture

HL-1 murine cardiomyocytes cells (Sigma-Aldrich, SCC065) were cultured in Claycomb Medium (Sigma-Aldrich, 51800C). 4-OI or itaconate (Sigma-Aldrich, I29204) was added to the Claycomb medium for 2 hours. The medium was then changed to cold HTK solution and incubated in an hypoxic incubation chamber (Stem cell technologies). The chamber cold hypoxic conditions consist premixed of 1% Oxygen and 5% Carbon dioxide gas (Cryogenic gases, Detroit MI) with cell culture at 4° C. for 2 hours. After cold preservation culture, the medium was changed to 37° C. DMEM at atmospheric conditions and cells were incubated for an additional 2 hours. Cell lysates were then collected for Western blot analysis.

### Statistical Analysis

Statistical examination of data was performed using Prism 7.0 (GraphPad Software). Comparison of mean values between groups was analyzed via unpaired two-tailed Student's t test, Kruskal Wallis test followed by Dunn's multiple comparisons test or analysis of variance (ANOVA) for multiple comparisons as indicated in figure legends. P values <0.05 were considered significant. Data regarding exact P values, definition and number of replicates are provided in the respective figure legends.

### Results

### HDAC Inhibitor Treatment Improves Donor Heart Function and Ischemic Tolerance

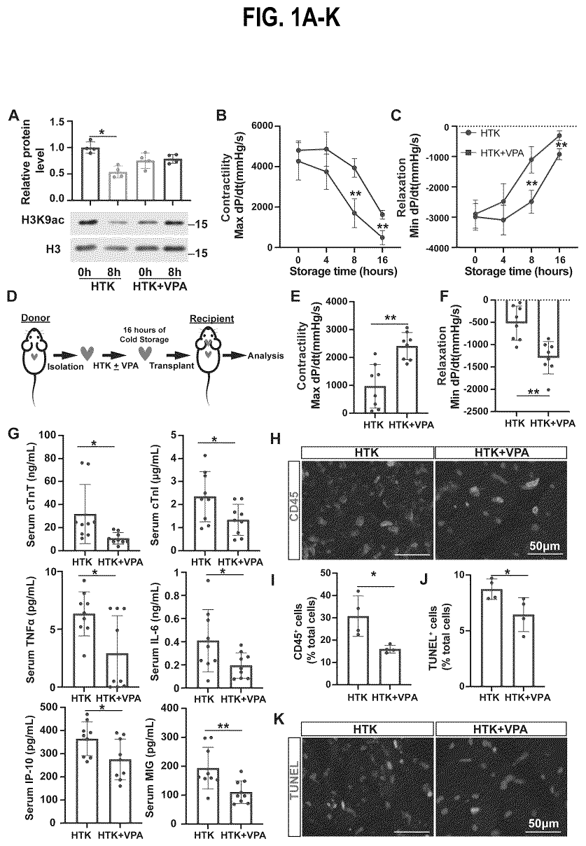

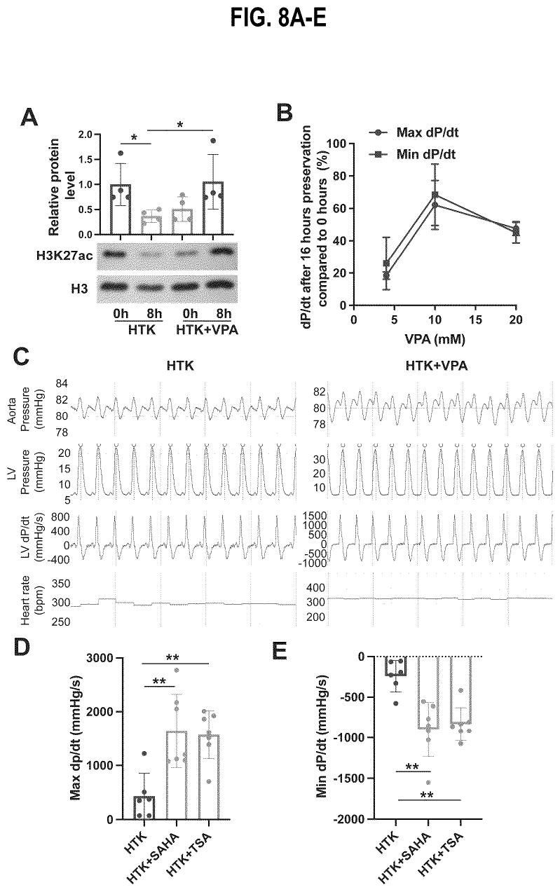

Cellular ischemia induces chromatin compaction with repression of gene transcription, and this is associated with histone deacetylation and methylation (18, 19). Western blotting confirmed that total H3K9 and H3K27 histone acetylation were decreased during human donor heart preservation (FIG. 1A and FIG. 8A). Acetylation of these histone tails is expected to activate gene expression as shown in prior studies (20). To test the potential of HDAC inhibitors to preserve donor heart function, human hearts were infused with Histidine-tryptophan-ketoglutarate (HTK) containing VPA followed by cold (4° C.) static preservation for 8 h. It was confirmed that this maintained histone acetylation after prolonged cardiac preservation (FIG. 1A and FIG. 8A). Assessment of ex vivo donor murine heart function with increased cold preservation time indicated that VPA could improve contractility for up to 16 hours, despite the worsening of cardiac function at this time point (FIG. 1, B and C). Titration of VPA concentration showed a peak cardioprotective effect at 10 mM (FIG. 8, B and C)

These experiments were extended to demonstrate that other HDAC inhibitors could also improve the quality of donor murine hearts in both ex vivo perfusion and transplant models. Suberoylanilide hydroxamic acid (SAHA) and Trichostatin A (TSA) both inhibit HDAC 1, 2, 3, and 6 (21) and are used for the treatment of various cancers (22, 23). Pharmacological inhibition of HDAC with SAHA or TSA improved ex vivo murine donor heart contractility and relaxation with ex vivo perfusion after 16 hours of cold preservation (FIG. 8, D and E). This indicates that the cardioprotective effect of HDAC inhibitors during donor heart preservation was not linked to an individual drug but more generally to its ability to inhibit HDAC activity. However, both SAHA (24) and TSA (25) are poorly water soluble, making them less suited for intravascular administration. In contrast, VPA is water soluble (26) and can be easily dissolved in the HTK used for infusion during clinical cardiac procurement.

Because there are no recipient infiltrating cellular responses during ex-vivo perfusion with Krebs buffer, the cardioprotective findings for VPA were confirmed in a sex-matched syngeneic mouse heart transplant model that incorporates recipient immune responses (FIG. 1D). VPA improved in vivo donor heart contractility (max dP/dt) and relaxation (min dP/dt) by 265% and 250%, respectively compared to standard HTK solution alone after 24 h reperfusion in the recipient (FIG. 1, E and F). Consistent with improved cardiac preservation, VPA treatment reduced serum troponin T and troponin I (FIG. 1G), which are known markers of myocardial damage. Furthermore, VPA reduced the serum concentrations of circulating cytokines (Tumor necrosis factor α (TNFα) IL-6) and chemokines (IP-10, monokine induced by interferon-y (MIG)) that were previously shown to be associated with dysfunction of transplanted donor hearts (FIG. 1G) (27-30). Accordingly, VPA treatment also reduced leukocyte infiltration (FIG. 1, H and I) and cell death in transplanted heart tissue (FIG. 1, J and K). These results suggested that HDAC inhibition could limit myocardial injury that occurs during cold ischemia and organ preservation.

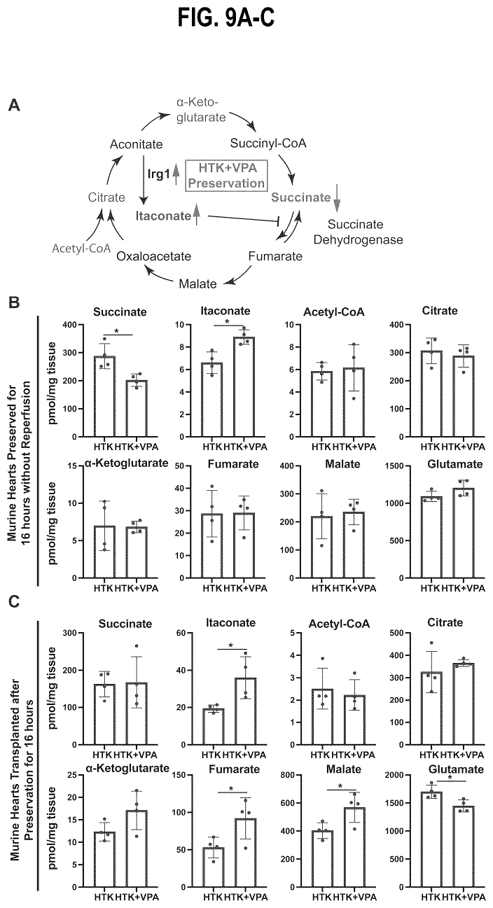

Metabolic reprogramming during cold preservation is achieved by administering VPA HDAC inhibitors that can modulate metabolic pathways. VPA and SAHA have been shown to decrease glycolysis and lipid metabolism (31, 32) whereas TSA has been found to increase aerobic and mitochondrial metabolism (33, 34). Because cardiac energetics have a key role in determining cardiac function, mass spectrometry was used to assess changes in the cardiac metabolic profiles of human and murine hearts with VPA treatment. During cold preservation of human hearts, succinate increased during cold ischemia (FIG. 2A). However, VPA treatment reduced this harmful succinate production (FIG. 2A). In contrast, the decrease in itaconate observed in HTK hearts during cold storage was limited by VPA (FIG. 2B, FIG. 9A). Findings of decreased succinate and increased itaconate with VPA treatment were conserved in murine hearts during cold static preservation (FIG. 9B) as well as transplantation (FIG. 9C). Itaconate concentrations during cardiac preservation in the VPA-treated groups of both species (human=8.0±1.0 pmol/mg tissue; mice=8.8±0.8 pmol/mg tissue, FIG. 2 and FIG. 9B) were a similar order of magnitude as fumarate (human=43.5±6.6 pmol/mg tissue; mice=29.0±7.5 pmol/mg tissue, FIG. 2C and FIG. 9C), suggesting itaconate could potentially act as a competitive inhibitor and limit fumarate binding to SDH (17). Whereas acetyl-CoA, citrate and α-ketoglutarate abundance all decreased during cold preservation in human hearts, no changes in acetyl-CoA, citrate, α-ketoglutarate, fumarate, or malate abundance were observed in murine hearts with VPA treatment during cold preservation (FIG. 2D-G and FIG. 9B and C). However, following murine heart transplantation, fumarate and malate were increased and glutamate decreased by VPA treatment (FIG. 9B and C).

### IRG1 Upregulation in the Donor Heart by VPA Results in Greater Cardioprotection

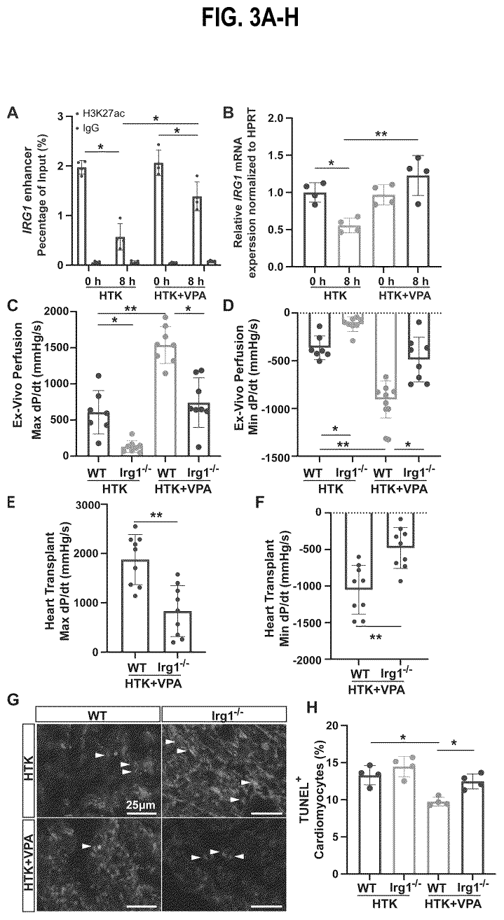

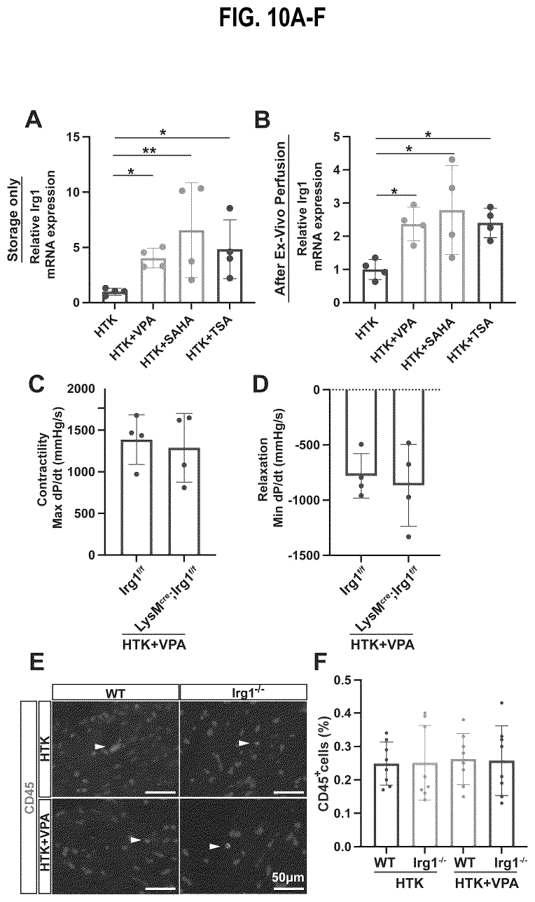

Given the increased availability of itaconate with VPA treatment, experiments were conducted during development of embodiments herein to to determine whether the expression of the source enzyme (IRG1) was specifically induced by VPA. Chromatin immunoprecipitation (ChIP) with H3K27ac antibody followed by qPCR showed that VPA treatment increased IRG1 enhancer activity in human heart tissue after 8-hours of preservation compared to HTK alone (FIG. 3A). Accordingly, IRG1 mRNA transcript expression also increased by treatment with VPA (FIG. 3B). During murine heart preservation without reperfusion (FIG. 10A) and during ex vivo perfusion (FIG. 10B), Irg1 transcript expression increased with all HDAC inhibitor treatments (VPA, SAHA and TSA). To further elucidate IRG1 's role in preserving donor hearts, preservation-reperfusion functional responses were examined in Irg1-mice. In both ex vivo perfusion (FIG. 3, C and D) and syngeneic transplant models (FIG. 3, E and F), a deficiency in Irg1 reduced the cardioprotective effects of VPA. Irg1-4-hearts also had poorer function than WT hearts without VPA treatment (FIG. 3, C and D). Although addition of VPA reduced TUNEL staining in α-actinin⁺ cardiomyocytes, this benefit was lost in Irg1^{-/-} hearts (FIG. 3G-H). To examine the contribution of IRG1 in myeloid cells, the effects of VPA treatment was examined in LysM-Cre hearts. Conditional Irg1 deficiency in myeloid cells did not impact VPA's cardioprotective effects on contractility or relaxation in the ex vivo perfusion model (FIG. 10, C and D). These results agreed with immunofluorescence staining for passenger leukocytes that indicated these cells are very rare in ex vivo perfused hearts (0.25% of total cells, FIG. 10, E and F). It was confirmed that IRG1 transcript expression by native cardiac cell populations including cardiomyocytes, fibroblasts, endothelial cells was comparable to myeloid cells as demonstrated by single-cell data from adult human hearts reported by Litviňuková et al (35). Thus, enhanced Irg1 expression and itaconate production by VPA in cardiac cells (cardiomyocytes, endothelial cells and/or fibroblasts) appear have a role in cardiac preservation.

### Enhanced Irg1 Expression Increased Expression of Cardiac Antioxidant Pathways

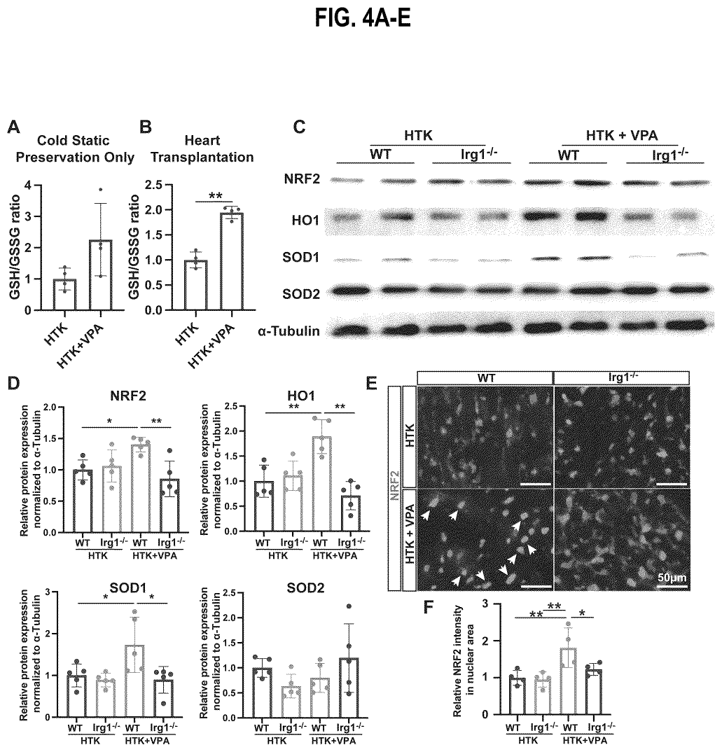

VPA also increased the ratio of reduced (Glutathione, GSH) versus oxidized glutathione (Glutathione disulfide, GSSG) in preserved and transplanted murine hearts (FIG. 4, A and B), consistent with reduced oxidative stress. VPA also upregulated the protein abundance of total nuclear factor erythroid 2-related factor2 (NRF2), hemeoxygenase 1 (HO1) and superoxide dismutase 1 (SOD1), but not superoxide dismutase 2 (SOD2) in ex vivo perfused WT murine hearts (FIG. 4, C and D). In Irg1^{-/-} murine hearts however, there was no increase in antioxidant protein expression (FIG. 4, C and D). This data indicates that Irg1 expression and increased itaconate availability was required for upregulation of antioxidant proteins by VPA. Previous reports have also shown that itaconate upregulated antioxidant proteins in immune cells such as macrophages (36); however, this is not well described in non-immune cardiac cells. Given the paucity of leukocytes in the ex vivo perfusion system, the beneficial upregulation of antioxidant proteins may be occurring within cardiac cells. Experiments did not detect any difference in antioxidant protein expression between WT versus Irg1^{-/-} hearts preserved with only HTK (FIG. 4, C and D).

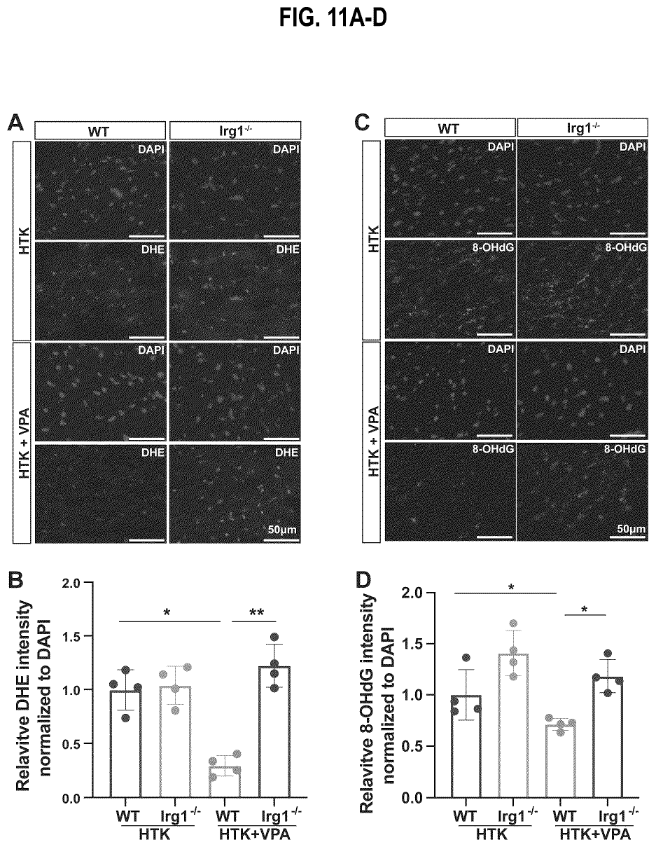

Itaconate is known to activate NRF2 via KEAP1 alkylation, thus facilitating anti-oxidant expression. Therefore, it was hypothesized that VPA activates the NRF2 pathway through Irg1/itaconate. WT hearts treated with VPA induced NRF2 nuclear translation from the cytoplasm consistent with activation but this effect was greatly reduced in Irg1^{-/-} hearts (FIG. 4E). NRF2 was located largely in the cytoplasm in wild type hearts preserved with HTK only or in VPA-treated Irg1^{-/-} hearts (FIG. 4E and F). VPA-treated hearts had a decrease in overall oxidative stress and oxidative DNA damage as demonstrated by decreased Dihydrocthidium (DHE) (FIGS. 11, A and B) and 8-hydroxy-2′-deoxyguanosine (8OHdG) (FIG. 11, C and D) staining, respectively. However, oxidative stress remained comparable between WT and Irg1^{-/-} hearts preserved with HTK and Irg1^{-/-} hearts treated with VPA (FIG. 11, A to D)

### Itaconate Derivatives Augment Heart Function and Antioxidant Signaling in Mice

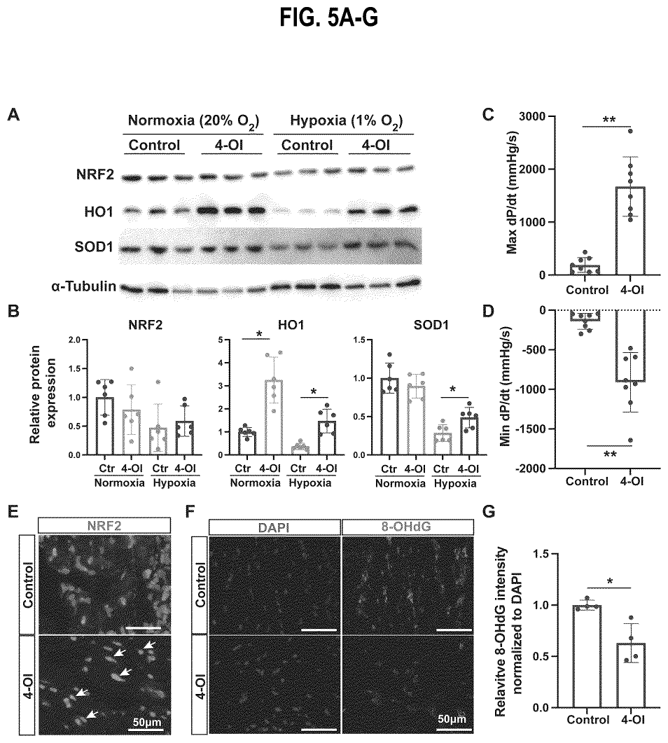

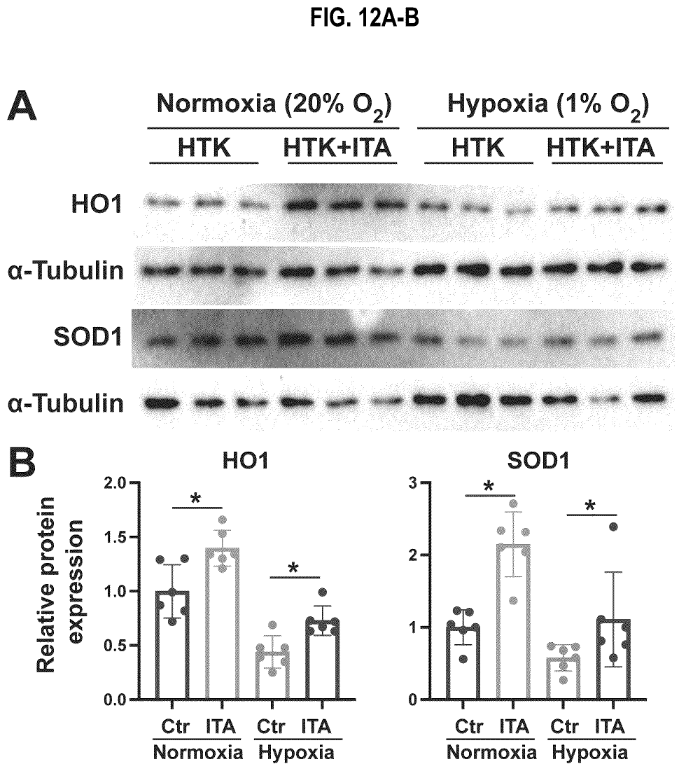

To directly assess the effects of itaconate, HL-1 cardiomyocytes were treated in vitro with either itaconate or 4 octyl-itaconate (4-OI) under both normoxic and hypoxic conditions. Treatment with either compound resulted in enhanced antioxidant HO1 and SOD1 protein abundance but no changes in NRF2 were observed (FIG. 5, A and B, FIG. 12, A and B). Itaconate has high polarity and low cell permeability; so the cell-permeable 4-OI (37) was for in vivo studies. Given the finding that Irg/upregulation by VPA improved cardiac preservation quality, 4-OI was directly administered to donor mice and then subjected donor hearts to 16 hours of preservation. Subsequent ex vivo perfusion showed that 4-OI treatment improved both cardiac contractility and relaxation (FIG. 5, C and D). 4-OI treatment also increased NRF2 nuclear translocation in cardiac tissue (FIG. 5E). Similar to VPA treatment, 4-OI also reduced oxidative DNA damage in donor hearts as shown by reduced 8-OHdG fluorescence (FIG. 5, F and G).

### VPA Improves Preservation of Porcine Cardiac Function Following Reperfusion

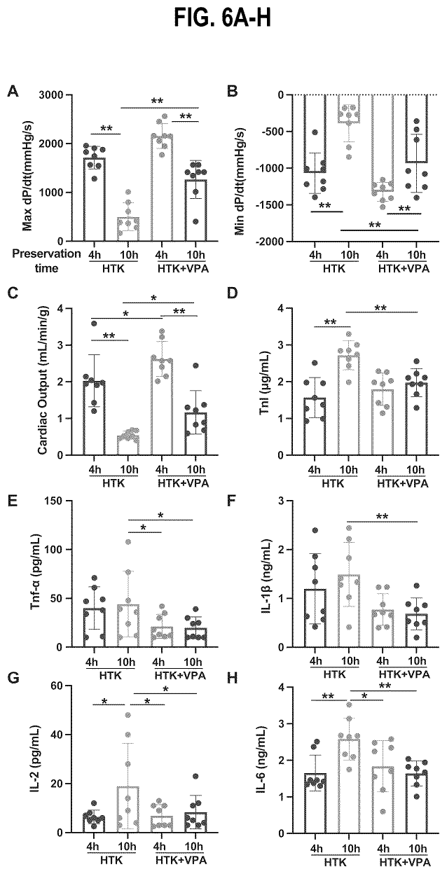

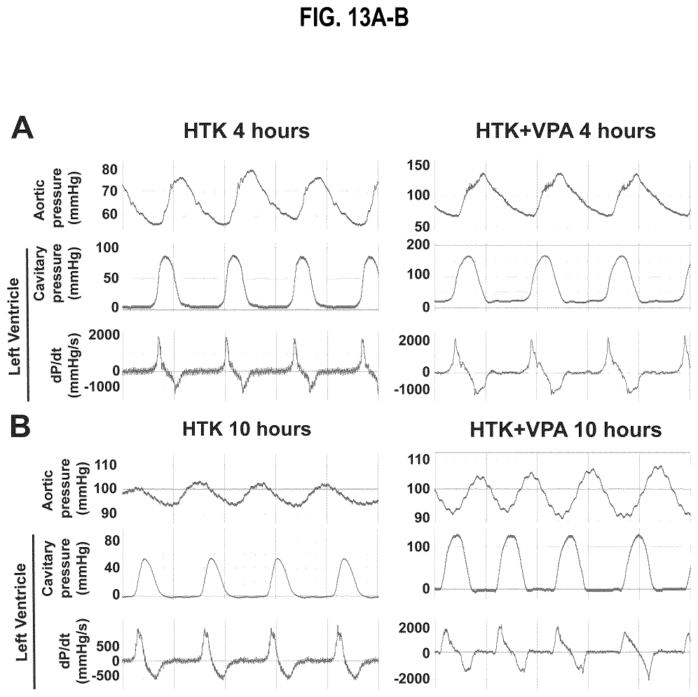

To determine the efficacy of VPA in large animals and to evaluate translatability into the clinical setting, VPA's effect on pig heart preservation and subsequent function was examined in an ex vivo perfusion system. VPA improved both donor heart contractility and relaxation in working mode (this loads the left heart chambers with volume to allow cardiac ejection to assess function) at both the 4 h and 10 h preservation time points (FIG. 6, A and -B, FIG. 13, A and B). Compared with HTK alone, VPA treatment improved cardiac output (CO) by about 25% after 4 h preservation and by 100% after 10 h of preservation (FIG. 6C). Improved cardiac function after 10 h of preservation was reflected by higher systolic pressure in the left ventricular cavity, and a greater aortic pulse pressure magnitude (systolic minus diastolic pressure). Oxygen consumption was also higher with VPA treatment but there was no difference in heart weight.

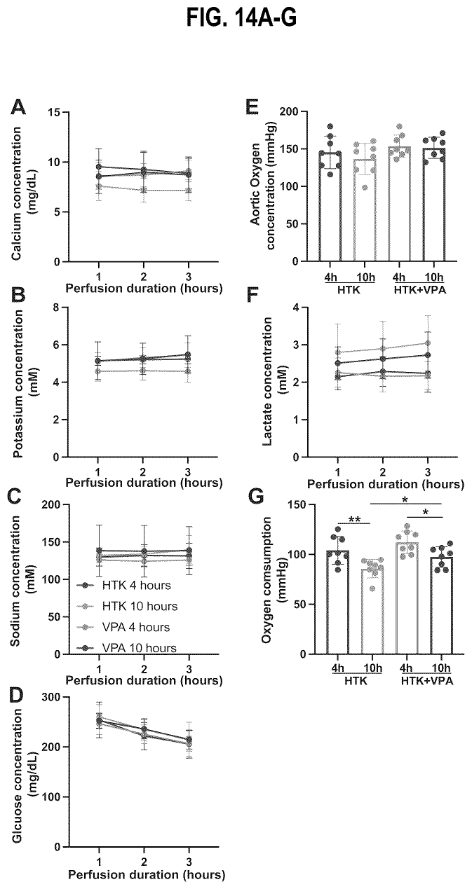

Electrolyte as well as O₂ concentration were maintained within normal range (38) (FIG. 14, A to E) for all groups. Lactate expression also remained low and stable for all groups during the 3-hour perfusion period (FIG. 14E). In pig hearts preserved for 10 h, oxygen consumption was greater in the VPA treatment group compared to HTK alone (FIG. 14F) which is consistent with greater myocardial viability following VPA treatment. VPA also reduced TnI measured in arterial perfusate and was indicative of reduced cardiac injury (FIG. 6D). Perfusate concentrations of inflammatory mediators TNF-α, IL-1β, IL-2 and IL-6 were also reduced by VPA in samples collected after 10 hours of preservation (FIG. 6, E to H).

### Upregulation of Antioxidant Proteins by VPA is Conserved Between Pig and Mice Hearts

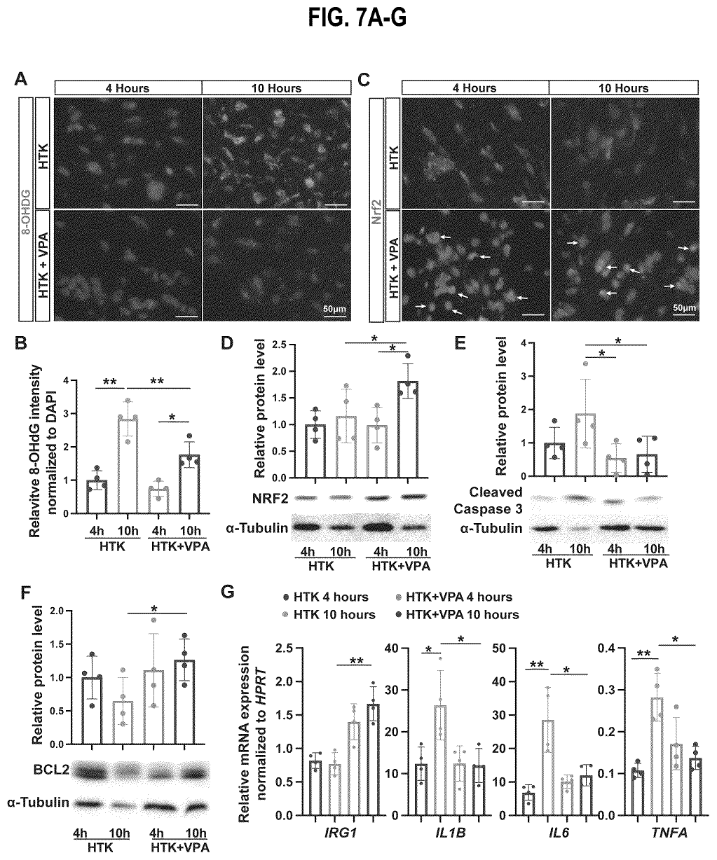

Experiments were conducted during development of embodiments herein to compare the antioxidant response in murine and procine hearts. As observed in mice, increasing oxidative DNA damage via 8-OHdG staining was readily seen in porcine hearts after 10 h preservation compared to 4 h, and this was greatly reduced by VPA treatment (FIG. 7, A and B). NRF2 was localized to the cytoplasm in ex vivo perfused pig heart cells after 4 and 10 hours of preservation whereas VPA induced NRF2 nuclear translocation at both preservation time points, consistent with NRF2 activation with downstream signal transduction (FIG. 7C). VPA also increased total Nrf2 protein in cardiac tissue (FIG. 7D).

In addition, VPA treatment decreased expression of cleaved caspase 3 expression, a cell death mediator (FIG. 7E) as well as increased expression of pro-survival protein BCL2 after 10 h preservation (FIG. 7F). Consistent with murine findings, VPA similarly increased the expression of IRG1 transcript and decreased mRNA abundance of inflammatory cytokines IL1B, IL6 and TNFA in ex vivo perfused hearts compared to HTK alone (FIG. 7G).

### REFERENCES

The following references, some of which are cited above by number, are herein incorporated by reference in their entirety.
1. S. L. Jackson, X. Tong, R. J. King, F. Loustalot, Y. Hong, M. D. Ritchey, National Burden of Heart Failure Events in the United States, 2006 to 2014. Circ Heart Fail 11, c004873 (2018).
2. E. M. Hsich, Matching the Market for Heart Transplantation. Circ Heart Fail 9, c002679 (2016).
3. S. S. A. Singh, J. R. Dalzell, C. Berry, N. Al-Attar, Primary graft dysfunction after heart transplantation: a thorn amongst the roses. Heart Fail Rev, (2019).
4. S. M. Minasian, M. M. Galagudza, Y. V. Dmitriev, A. A. Karpov, T. D. Vlasov, Preservation of the donor heart: from basic science to clinical studies. Interact Cardiovasc Thorac Surg 20, 510-519 (2015).
5. S. S. A. Singh, J. R. Dalzell, C. Berry, N. Al-Attar, Primary graft dysfunction after heart transplantation: a thorn amongst the roses. Heart Fail Rev 24, 805-820 (2019).
6. A. Nicoara, D. Ruffin, M. Cooter, C. B. Patel, A. Thompson, J. N. Schroder, M. A. Daneshmand, A. F. Hernandez, J. G. Rogers, M. V. Podgorcanu, M. Swaminathan, A. Kretzer, M. Stafford-Smith, C. A. Milano, R. R. Bartz, Primary graft dysfunction after heart transplantation: Incidence, trends, and associated risk factors. Am J Transplant 18, 1461-1470 (2018).
7. J. Schroder,; D'Alessandro, F E,; Bocve, T,; Tang, P,; Liao, K,; Wang, I,: Anyanwu, A,; Shah, A,: Mudy, K,; Soltesz, E,; Smith, J W., Successful Utilization of Extended Criteria Donor (ECD) Hearts for Transplantation-Results of the OCSTM Heart EXPAND Trial to Evaluate the Effectiveness and Safety of the OCS Heart System to Preserve and Assess ECD Hearts for Transplantation. The Journal of Heart and Lung Transplantation 38, S42 (2019).
8. S. Toldo, M. Quader, F. N. Salloum, E. Mezzaroma, A. Abbate, Targeting the Innate Immune Response to Improve Cardiac Graft Recovery after Heart Transplantation: Implications for the Donation after Cardiac Death. Int J Mol Sci 17, (2016).
9. J. L. Martin, A. S. H. Costa, A. V. Gruszczyk, T. E. Beach, F. M. Allen, H. A. Prag, E. C. Hinchy, K. Mahbubani, M. Hamed, L. Tronci, E. Nikitopoulou, A. M. James, T. Krieg, A. J. Robinson, M. M. Huang, S. T. Caldwell, A. Logan, L. Pala, R. C. Hartley, C. Frezza, K. Saeb-Parsy, M. P. Murphy, Succinate accumulation drives ischacmia-reperfusion injury during organ transplantation. Nat Metab 1, 966-974 (2019).
10. E. T. Chouchani, V. R. Pell, E. Gaude, D. Aksentijevic, S. Y. Sundier, E. L. Robb, A. Logan, S. M. Nadtochiy, E. N. J. Ord, A. C. Smith, F. Eyassu, R. Shirley, C. H. Hu, A. J. Dare, A. M. James, S. Rogatti, R. C. Hartley, S. Eaton, A. S. H. Costa, P. S. Brookes, S. M. Davidson, M. R. Duchen, K. Saeb-Parsy, M. J. Shattock, A. J. Robinson, L. M. Work, C. Frezza, T. Krieg, M. P. Murphy, Ischaemic accumulation of succinate controls reperfusion injury through mitochondrial ROS. Nature 515, 431-435 (2014).
11. A. P. Feinberg, The Key Role of Epigenetics in Human Disease Prevention and Mitigation. N Engl J Med 378, 1323-1334 (2018).
12. T. Kalogeris, C. P. Baines, M. Krenz, R. J. Korthuis, Cell biology of ischemia/reperfusion injury. Int Rev Cell Mol Biol 298, 229-317 (2012).
13. S. Schweizer, A. Meisel, S. Marschenz, Epigenetic mechanisms in cerebral ischemia. J Cereb Blood Flow Metab 33, 1335-1346 (2013).
14. M. Haberland, R. L. Montgomery, E. N. Olson, The many roles of histone deacetylases in development and physiology: implications for disease and therapy. Nat Rev Genet 10, 32-42 (2009).
15. R. Benedetti, M. Conte, L. Altucci, Targeting Histone Deacetylases in Discases: Where Are We? Antioxid Redox Signal 23, 99-126 (2015).
16. I. Halaweish, V. Nikolian, P. Georgoff, Y. Li, H. B. Alam, Creating a “Prosurvival Phenotype” Through Histone Deacetylase Inhibition: Past, Present, and Future. Shock 44 Suppl 1, 6-16 (2015).
17. F. Chen, W. A. M. Elgaher, M. Winterhoff, K. Bussow, F. H. Waqas, E. Graner, Y. Pires-Afonso, L. Casares Perez, L. de la Vega, N. Sahini, L. Czichon, W. Zobl, T. Zillinger, M. Shehata, S. Pleschka, H. Bahre, C. Falk, A. Michelucci, S. Schuchardt, W. Blankenfeldt, A. K. H. Hirsch, F. Pessler, Citraconate inhibits ACODI (IRG1) catalysis, reduces interferon responses and oxidative stress, and modulates inflammation and cell metabolism. Nat Metab 4, 534-546 (2022).
18. I. Kirmes, A. Szczurek, K. Prakash, I. Charapitsa, C. Heiser, M. Mushccv, F. Schock, K. Fornalczyk, D. Ma, U. Birk, C. Cremer, G. Reid, A transient ischemic environment induces reversible compaction of chromatin. Genome Biol 16, 246 (2015).
19. A. A. Chakraborty, T. Laukka, M. Myllykoski, A. E. Ringel, M. A. Booker, M. Y. Tolstorukov, Y. J. Meng, S. R. Meier, R. B. Jennings, A. L. Creech, Z. T. Herbert, S. K. McBrayer, B. A. Olenchock, J. D. Jaffe, M. C. Haigis, R. Beroukhim, S. Signoretti, P. Koivunen, W. G. Kaclin, Jr., Histone demethylase KDM6A directly senses oxygen to control chromatin and cell fate. Science 363, 1217-1222 (2019).
20. E. Calo, J. Wysocka, Modification of enhancer chromatin: what, how, and why? Mol Cell 49, 825-837 (2013).
21. A. C. West, R. W. Johnstone, New and emerging HDAC inhibitors for cancer treatment. J Clin Invest 124, 30-39 (2014).
22. P. A. Marks, Discovery and development of SAHA as an anticancer agent. Oncogene 26, 1351-1356 (2007).
23. J. Chang, D. S. Varghese, M. C. Gillam, M. Peyton, B. Modi, R. L. Schiltz, L. Girard, E. D. Martinez, Differential response of cancer cells to HDAC inhibitors trichostatin A and depsipeptide. Br J Cancer 106, 116-125 (2012).
24. A. K. Mcka, L. J. Jenkins, M. Davalos-Salas, N. Pujara, K. Y. Wong, T. Kumcria, J. M. Mariadason, A. Popat, Enhanced Solubility, Permeability and Anticancer Activity of Vorinostat Using Tailored Mesoporous Silica Nanoparticles. Pharmaceutics 10, (2018).
25. G. Urbinati, V. Marsaud, V. Plassat, E. Fattal, S. Lesieur, J. M. Renoir, Liposomes loaded with histone deacetylase inhibitors for breast cancer therapy. Int J Pharm 397, 184-193 (2010).
26. I. A. Alsarra, M. Al-Omar, F. Belal, Valproic Acid and sodium valproate: comprehensive profile. Profiles Drug Subst Excip Relat Methodol 32, 209-240 (2005).
27. E. J. Birks, P. B. Burton, V. Owen, A. J. Mullen, D. Hunt, N. R. Banner, P. J. Barton, M. H. Yacoub, Elevated tumor necrosis factor-alpha and interleukin-6 in myocardium and scrum of malfunctioning donor hearts. Circulation 102, III352-358 (2000).
28. G. Plenz, H. Eschert, M. Erren, T. Wichter, M. Bohm, M. Flesch, H. H. Scheld, M. C. Deng, The interleukin-6/interleukin-6-receptor system is activated in donor hearts. J Am Coll Cardiol 39, 1508-1512 (2002).
29. C. Crescioli, A. Buonamano, S. Scolletta, M. Sottili, M. Francalanci, P. Giomarelli, B. Biagioli, G. Lisi, F. Pradella, M. Serio, P. Romagnani, M. Maccherini, Predictive role of pretransplant serum CXCL10 for cardiac acute rejection. Transplantation 87, 249-255 (2009).
30. J. A. Belperio, A. Ardchali, Chemokines and transplant vasculopathy. Circ Res 103, 454-466 (2008).
31. P. Rajendran, D. E. Williams, E. Ho, R. H. Dashwood, Metabolism as a key to histone deacetylase inhibition. Crit Rev Biochem Mol Biol 46, 181-199 (2011).
32. S. E. Wardell, O. R. Ilkayeva, H. L. Wicman, D. E. Frigo, J. C. Rathmell, C. B. Newgard, D. P. McDonnell, Glucose metabolism as a target of histone deacetylase inhibitors. Mol Endocrinol 23, 388-401 (2009).
33. N. D. Amocdo, M. F. Rodrigues, P. Pezzuto, A. Galina, R. M. da Costa, F. C. de Almeida, T. El-Bacha, F. D. Rumjanek, Energy metabolism in H460 lung cancer cells: effects of histone deacetylase inhibitors. PLOS One 6, c22264 (2011).
34. R. Furumai, Y. Komatsu, N. Nishino, S. Khochbin, M. Yoshida, S. Horinouchi, Potent histone deacetylase inhibitors built from trichostatin A and cyclic tetrapeptide antibiotics including trapoxin. Proc Natl Acad Sci USA 98, 87-92 (2001).
35. M. Litvinukova, C. Talavera-Lopez, H. Maatz, D. Reichart, C. L. Worth, E. L. Lindberg, M. Kanda, K. Polanski, M. Heinig, M. Lec, E. R. Nadelmann, K. Roberts, L. Tuck, E. S. Fasouli, D. M. DeLaughter, B. McDonough, H. Wakimoto, J. M. Gorham, S. Samari, K. T. Mahbubani, K. Saeb-Parsy, G. Patone, J. J. Boyle, H. Zhang, H. Zhang, A. Viveiros, G. Y. Oudit, O. A. Bayraktar, J. G. Seidman, C. E. Seidman, M. Noseda, N. Hubner, S. A. Teichmann, Cells of the adult human heart. Nature 588, 466-472 (2020).
36. L. A. J. O'Neill, M. N. Artyomov, Itaconate: the poster child of metabolic reprogramming in macrophage function. Nat Rev Immunol 19, 273-281 (2019).
37. S. T. Liao, C. Han, D. Q. Xu, X. W. Fu, J. S. Wang, L. Y. Kong, 4-Octyl itaconate inhibits aerobic glycolysis by targeting GAPDH to exert anti-inflammatory effects. Nat Commun 10, 5091 (2019).
38. in Laboratory Medicine: The Diagnosis of Disease in the Clinical Laboratory, M. Laposata, Ed. (McGraw-Hill Education, New York, NY, 2014).
39. Y. Moayedi, C. P. S. Fan, W. S. Cherikh, J. Stehlik, J. J. Teuteberg, H. J. Ross, K. K. Khush, Survival Outcomes After Heart Transplantation: Does Recipient Sex Matter? Circ Heart Fail 12, c006218 (2019).
40. C. Tabula Muris, c. Overall, c. Logistical, c. Organ, processing, p. Library, sequencing, a. Computational data, a. Cell type, g. Writing, g. Supplemental text writing, i. Principal, Single-cell transcriptomics of 20 mouse organs creates a Tabula Muris. Nature 562, 367-372 (2018).
41. V. Lampropoulou, A. Sergushichev, M. Bambouskova, S. Nair, E. E. Vincent, E. Loginicheva, L. Cervantes-Barragan, X. Ma, S. C. Huang, T. Griss, C. J. Weinheimer, S. Khader, G. J. Randolph, E. J. Pearce, R. G. Jones, A. Diwan, M. S. Diamond, M. N. Artyomov, Itaconate Links Inhibition of Succinate Dehydrogenase with Macrophage Metabolic Remodeling and Regulation of Inflammation. Cell Metab 24, 158-166 (2016).
42. S. F. Waqas, A. Sohail, A. H. H. Nguyen, A. Usman, T. Ludwig, A. Wegner, M. N. H. Malik, S. Schuchardt, R. Geffers, M. Winterhoff, S. Merkert, U. Martin, R. Olmer, N. Lachmann, F. Pessler, ISG15 deficiency features a complex cellular phenotype that responds to treatment with itaconate and derivatives. Clin Transl Med 12, c931 (2022).
43. S. Nair, J. P. Huynh, V. Lampropoulou, E. Loginicheva, E. Esaulova, A. P. Gounder, A. C. M. Boon, E. A. Schwarzkopf, T. R. Bradstreet, B. T. Edelson, M. N. Artyomov, C. L. Stallings, M. S. Diamond, Irg1 expression in myeloid cells prevents immunopathology during M. tuberculosis infection. J Exp Med 215, 1035-1045 (2018).
44. A. S. Bailey, H. Willenbring, S. Jiang, D. A. Anderson, D. A. Schroeder, M. H. Wong, M. Grompe, W. H. Fleming, Myeloid lineage progenitors give rise to vascular endothelium. Proc Natl Acad Sci USA 103, 13156-13161 (2006).
45. P. C. Kuo, W. T. Weng, B. A. Scofield, H. C. Paraiso, D. A. Brown, P. Y. Wang, I. C. Yu, J. H. Yen, Dimethyl itaconate, an itaconate derivative, exhibits immunomodulatory effects on neuroinflammation in experimental autoimmune encephalomyelitis. J Neuroinflammation 17, 138 (2020).
46. M. Bambouskova, L. Gorvel, V. Lampropoulou, A. Sergushichev, E. Loginicheva, K. Johnson, D. Korenfeld, M. E. Mathyer, H. Kim, L. H. Huang, D. Duncan, H. Bregman, A. Keskin, A. Santeford, R. S. Apte, R. Schgal, B. Johnson, G. K. Amarasinghe, M. P. Soares, T. Satoh, S. Akira, T. Hai, C. de Guzman Strong, K. Auclair, T. P. Roddy, S. A. Biller, M. Jovanovic, E. Klechevsky, K. M. Stewart, G. J. Randolph, M. N. Artyomov, Electrophilic properties of itaconate and derivatives regulate the IkappaBzeta-ATF3 inflammatory axis. Nature 556, 501-504 (2018).
47. G. Atefi, F. S. Zetoune, T. J. Herron, J. Jalife, M. Bosmann, R. Al-Aref, J. V. Sarma, P. A. Ward, Complement dependency of cardiomyocyte release of mediators during sepsis. FASEB J 25, 2500-2508 (2011).
48. N. G. Frangogiannis, The inflammatory response in myocardial injury, repair, and remodelling. Nat Rev Cardiol 11, 255-265 (2014).
49. D. D. H. Koo, S. V. Fuggle, Chemokines in ischemia/reperfusion injury. Current Opinion in Organ Transplantation 7, 100-106 (2002).
50. S. B. Ong, S. Hernandez-Resendiz, G. E. Crespo-Avilan, R. T. Mukhametshina, X. Y. Kwek, H. A. Cabrera-Fuentes, D. J. Hausenloy, Inflammation following acute myocardial infarction: Multiple players, dynamic roles, and novel therapeutic opportunities. Pharmacol Ther 186, 73-87 (2018).
51. Y. Shen, X. Liu, J. Shi, X. Wu, Involvement of Nrf2 in myocardial ischemia and reperfusion injury. Int J Biol Macromol 125, 496-502 (2019).
52. E. L. Mills, D. G. Ryan, H. A. Prag, D. Dikovskaya, D. Menon, Z. Zaslona, M. P. Jedrychowski, A. S. H. Costa, M. Higgins, E. Hams, J. Szpyt, M. C. Runtsch, M. S. King, J. F. McGouran, R. Fischer, B. M. Kessler, A. F. McGettrick, M. M. Hughes, R. G. Carroll, L. M. Booty, E. V. Knatko, P. J. Meakin, M. L. J. Ashford, L. K. Modis, G. Brunori, D. C. Sevin, P. G. Fallon, S. T. Caldwell, E. R. S. Kunji, E. T. Chouchani, C. Frezza, A. T. Dinkova-Kostova, R. C. Hartley, M. P. Murphy, L. A. O'Neill, Itaconate is an anti-inflammatory metabolite that activates Nrf2 via alkylation of KEAP1. Nature 556, 113-117 (2018).
53. S. Zhou, W. Sun, Z. Zhang, Y. Zheng, The role of Nrf2-mediated pathway in cardiac remodeling and heart failure. Oxid Med Cell Longev 2014, 260429 (2014).
54. A. Reddy, L. H. M. Bozi, O. K. Yaghi, E. L. Mills, H. Xiao, H. E. Nicholson, M. Paschini, J. A. Paulo, R. Garrity, D. Laznik-Bogoslavski, J. C. B. Ferreira, C. S. Carl, K. A. Sjoberg, J. F. P. Wojtaszewski, J. F. Jeppesen, B. Kiens, S. P. Gygi, E. A. Richter, D. Mathis, E. T. Chouchani, pH-Gated Succinate Secretion Regulates Muscle Remodeling in Response to Exercise. Cell 183, 62-75 c17 (2020).
55. M. Trauclsen, T. K. Hiron, D. Lin, J. E. Petersen, B. Breton, A. S. Husted, S. A. Hjorth, A. Inouc, T. M. Frimurer, M. Bouvier, C. A. O'Callaghan, T. W. Schwartz, Extracellular succinate hyperpolarizes M2 macrophages through SUCNR1/GPR91-mediated Gq signaling. Cell Rep 35, 109246 (2021).
56. J. L. Martin, A. S. H. Costa, A. V. Gruszczyk, T. E. Beach, F. M. Allen, H. A. Prag, E. C. Hinchy, K. Mahbubani, M. Hamed, L. Tronci, E. Nikitopoulou, A. M. James, T. Krieg, A. J. Robinson, M. H. Huang, S. T. Caldwell, A. Logan, L. Pala, R. C. Hartley, C. Frezza, K. Saeb-Parsy, M. P. Murphy, Succinate accumulation drives ischaemia-reperfusion injury during organ transplantation. Nat Metab 1, 966-974 (2019).
57. A. Swain, M. Bambouskova, H. Kim, P. S. Andhey, D. Duncan, K. Auclair, V. Chubukov, D. M. Simons, T. P. Roddy, K. M. Stewart, M. N. Artyomov, Comparative evaluation of itaconate and its derivatives reveals divergent inflammasome and type I interferon regulation in macrophages. Nat Metab 2, 594-602 (2020).
58. T. Tomson, D. Battino, E. Perucca, Valproic acid after five decades of use in epilepsy: time to reconsider the indications of a time-honoured drug. Lancet Neurol 15, 210-218 (2016).
59. A. Matsuura, T. Abc, K. Yasuura, Simplified mouse cervical heart transplantation using a cuff technique. Transplantation 51, 896-898 (1991).
60. A. Iyer, L. Gao, A. Doyle, P. Rao, J. R. Cropper, C. Soto, A. Dinale, G. Kumarasinghe, A. Jabbour, M. Hicks, P. C. Jansz, M. P. Fencley, R. P. Harvey, R. M. Graham, K. K. Dhital, P. S. MacDonald, Normothermic ex vivo perfusion provides superior organ preservation and enables viability assessment of hearts from DCD donors. Am J Transplant 15, 371-380 (2015).
61. S. Hatami, C. W. White, X. Qi, M. Buchko, M. Ondrus, A. Kinncar, S. Himmat, C. Sergi, J. Nagendran, D. H. Freed, Immunity and Stress Responses Are Induced During Ex Situ Heart Perfusion. Circ Heart Fail 13, c006552 (2020).
62. Y. Hao, S. Hao, E. Andersen-Nissen, W. M. Mauck, 3rd, S. Zheng, A. Butler, M. J. Lec, A. J. Wilk, C. Darby, M. Zager, P. Hoffman, M. Stocckius, E. Papalexi, E. P. Mimitou, J. Jain, A. Srivastava, T. Stuart, L. M. Fleming, B. Yeung, A. J. Rogers, J. M. McElrath, C. A. Blish. R. Gottardo. P. Smibert. R. Satija. Integrated analysis of multimodal single-cell data. Cell 184, 3573-3587 c3529 (2021).

1. A preservation fluid comprising a solution of itaconate, 4-octyl itaconate, dimethyl itaconate, or citraconate.

2. (canceled)

3. The preservation fluid of claim 1, further comprising buffer selected from phosphate, bicarbinate, and histidine.

4. (canceled)

5. The preservation fluid of claim 1, further comprising a physiologically-relevant concentrations of cations and anions selected from potassium, calcium, magnesium, chloride, bicarbinate, hydroxide, and sulfate ions.

6. (canceled)

7. The preservation fluid of claim 1, wherein the cations and anions are independently present at 0.01 to 200 mM.

8. The preservation fluid of claim 1, having an osmolarity of 250-500 mOsm/L.

9. (canceled)

10. The preservation fluid of claim 1, wherein the itaconate and/or an itaconate derivative is present at a concentration of 5-50 mM.

11-12. (canceled)

13. The preservation fluid of claim 1, further comprising one or more impermeants, antioxidants, and/or other components; wherein the one or more impermeants are selected from lucose, LactoB, raffinose, mannitol, dextran, and albumin; wherein the one or more antioxidants are selected from allopurinol (AlloP), glutathione (GSH), tryptophan (Trp), and mannitol; and wherein the one or more other components selected from α-ketoglutarate, dextran, blood, heparin, glucose, adenosine, and an amiloride-containing compound.

14-16. (canceled)

17. The preservation fluid of claim 1, further comprising:
(a) a mineralocorticoid receptor antagonist selected from spironolactone, eplerenone, canrenoic acid, canrenone, and drospirenone;
(b) a aldehyde dehydrogenase agonist selected from Alda-1, Alda-89, Alda-52, Alda-59, Alda-72, Alda-71, Alda-53, Alda-54, Alda-61, Alda-60, Alda-66, Alda-65, Alda-64, and Alda-84, and/or
(c) a histone deacetylase inhibitor selected from a hydroxamic acid, depsipeptide, benzamide; electrophilic ketone, phenylbutyrate and valproic acid, nicotinamide, and NA derivatives.

18-22. (canceled)

23. A method of preserving an organ or tissue comprising exposing the organ to a preservation fluid of claim 1.

24-25. (canceled)

26. The method of claim 23, wherein the organ or tissue is selected from a heart, kidneys, liver, lungs, pancreas, intestine, thymus, bones, tendons, corneae, skin, heart valves, nerves and veins.

27-29. (canceled)

30. The method of claim 23, wherein the organ is a heart.

31. The method of claim 30, further comprising arresting the heart with a cardioplegic solution prior to removal from the donor.

32. (canceled)

33. A method comprising administering itaconate and/or an itaconate derivative to subject.

34. The method of claim 33, wherein the subject has suffered a tissue and/or organ injury.

35-36. (canceled)

37. The method of claim 34, wherein the tissue and/or organ injury comprises cardiac damage or ischemic damage.

38. (canceled)

39. The method of claim 34, where the subject has suffered a myocardial infarction, cardiac arrest, and/or a stroke.

40. The method of claim 33, wherein the subject suffers from cardiotoxicity.

41-42. (canceled)

43. The method of claim 33, wherein the subject suffers from cancer in a subject with reduced cardiotoxicity, the method further comprising co-administering a chemotherapeutic to the subject.

44. The method of claim 33, wherein the administering results in reducing senescence in the subject.

45. The method of claim 33, wherein the administering results in preventing or reducing the likelihood of acute heart failure, chronic heart failure, and/or cardiomyopathies in a subject comprising administering itaconate and/or an itaconate derivative to the subject.

46. (canceled)
